(19) United States
(12) Patent Application Publication
(10) Pub. No.: US 2014/0344077 A1
(43) Pub. Date: Nov. 20, 2014

(54) USED INDUSTRIAL EQUIPMENT SALES APPLICATION SUITES, SYSTEMS, AND RELATED APPARATUS AND METHODS

(71) Applicant: CONTACT MARKETING SERVICES, INC., Austin, TX (US)

(72) Inventor: Steve Smith, Austin, TX (US)

(73) Assignee: CONTACT MARKETING SERVICES, INC., Austin, TX (US)

(21) Appl. No.: 14/216,644

(22) Filed: Mar. 17, 2014

Related U.S. Application Data
(60) Provisional application No. 61/793,010, filed on Mar. 15, 2013.

(51) Int. Cl. G06Q 30/00; G06Q 30/02; G06Q 30/06

(52) U.S. Cl. CPC G06Q 30/018; G06Q 30/0601; G06Q 30/0277
USPC 705/14.73

(57) ABSTRACT

Used industrial equipment sales systems and related apparatus and methods. Servers of embodiments store files of information regarding conditions of pieces of used industrial equipment. That information further comprises an inspection report configured to reflect the type of industrial equipment to which the piece of used industrial equipment belongs and to reflect predetermined components associated with the equipment type. Note that client devices are configured to access the file, ascertain the equipment type, and display the report. Inspection reports can include voice notes and multimedia files. Moreover, the reports can be location and/or time stamped. If desired, the client devices can indicate a service status of a piece of equipment wherein the inspection reports remain private while the service status is incomplete. In addition, or in the alternative, the inspection reports can have associated therewith indications of their trustworthiness. Thus, systems of embodiments can establish trusted environments.

### CROSS REFERENCE TO RELATED APPLICATIONS

This application claims priority to and is a non provisional application of U.S. provisional patent application No. 61/793,010 titled Equipment Application Suite, filed by Steve Smith on Mar. 15, 2013 the entirety of which is incorporated herein as if set forth in full.

### BACKGROUND

Many jokes use used cars salesman as their butts, and for good reason. The purchaser of a used car often has no, or little, idea of the real, underlying condition of a particular used car. Moreover, the used car salesman and/or dealer sometimes has good reason to hide, obscure, skirt around, etc. issues underlying that condition. For instance, the car might have been poorly maintained, driven hard, required undue maintenance, etc. These and other considerations also apply to the purchase of used industrial equipment.

However, used industrial equipment has associated with it, a slew of other considerations. For one thing, a purchaser looking for a particular type/piece of used industrial equipment cannot practicably travel to the location of each piece of used industrial equipment which might pique their interest. Thus, the opportunities to actually inspect each potential acquisition are limited if not non-existent. Moreover, with heretofore-available advertising systems, no way exists for the potential purchaser to know that they are receiving information regarding all (or a substantial portion) of the components of any piece of equipment that they might have an interest in. Of course, the vast variety of industrial equipment available on the re-sale market complicates these problems in that no one previously available system can accommodate that vast variety. Furthermore, as unfortunate as it might be, there exist certain players in the industry that will either intentionally and/or negligently present an inaccurate description of the condition of pieces of used industrial equipment which they seek to sell.

### SUMMARY

The following presents a simplified summary in order to provide an understanding of some aspects of the disclosed subject matter. This summary is not an extensive overview of the disclosed subject matter, and is not intended to identify key/critical elements or to delineate the scope of such subject matter. A purpose of the summary is to present some concepts in a simplified form as a prelude to the more detailed disclosure that is presented herein. The current disclosure provides systems, apparatus, methods, etc. for providing inspection reports regarding used industrial equipment and, more particularly, for doing so in trusted environments.

Individuals, organizations, and/or companies seeking to buy used industrial equipment face problems familiar to those who might wish to purchase a used automobile. Often the sellers cannot be trusted (or at least the buyers are reluctant to trust them) and the available automobiles might be in less than stellar condition. The variety of automobiles on the market complicate this matter because their listed conditions might/might not reflect the peculiarities of the various makes, models, option packages, and/or the like in which these automobiles are available. Moreover, whereas the used automobiles (and perhaps buyers) are usually located in a particular vicinity, at least some of the sellers are located remotely therefrom. Thus, obtaining first hand information regarding the condition of the available cars, trucks, SUVs, etc. can be difficult if not impossible for the potential buyers.

Industrial equipment also poses additional problems for both buyers and sellers alike. For instance, whereas certain networks (for instance CARFAX®) exist for gathering information about used cars, no such network is known to exist for used industrial equipment. And those advertising websites which do exist provide no systemized way to account for the limited differences between various automobiles makes, models, years, etc. The variety of industrial equipment, of course, dwarves the relatively limited variety found in the used car market. For instance, all cars include bodies, frames, engines, transmissions, and wheels. But, not all used industrial equipment includes mechanized buckets, grading blades, shovels, drilling derricks, water tanks, and so forth and so on. Thus, to the extent that condition reports might exist for used industrial equipment, even these “reports” provide spotty and/or incomplete information at best.

Embodiments provide systems, servers, mobile devices, etc. which allow users to capture condition information in the field and to manage the sell/buy process in systematic and trusted manners. Some embodiments comprise mobile applications which facilitate these actions via smart/mobile devices, associated user settings and/or sharing features so that users can communicate in real time and with good information, thereby leading to better decisions. Such sharing features can be customized and/or derived from group configurations based on individual identities, companies, and/or user types. Furthermore, information sharing can be via text messages, emails, etc. Listing notifications can be based on exact matches, partial matches, system generated suggestions, etc. The matching/suggestions, moreover, can also be based on user types, settings, and/or preferences.

Technology platforms of embodiments use cloud services-based technology stacks which allow immediate creation of equipment listings, management of these listings, and/or custom sales/group configurations based on the identities of the various users and their role types. Such platforms allow the users to communicate in real time using their smart devices to buy/sell equipment more efficiently using photos, video and inspection forms. The latter being pre-configured for the various types of used industrial equipment available for purchase/sell. These platforms provide these services within Software as a Service (SaaS) environments which allow each user to create and manage their own accounts based on their user types, roles and desired functionality.

Platforms of embodiments supply the information desired by the users, and nothing more (until/unless requested), for typical tasks associated with the buying and selling of equipment. They also provide a number of sought after capabilities. For instance, they allow users to create their accounts (be they individual, group, or company accounts) with customizable sharing features and user selected settings determining the platforms' functionality. Some platforms allow administrative users to create inspection forms which can be based on various industries, equipment types, equipment makes, equipment models, user types, etc. Moreover these inspection forms can provide for the inclusion of videos, photos, and/or reports customized by the users. For instance, some inspection forms can prompt users to add inspection data regarding option packages not listed elsewhere on the form and/or unique features of the equipment.

Platforms of embodiments also allow users to manage their listings and/or to recall their past activity. Such platforms can allow users to manage their leads, quotes, service requests, etc. and/or to archive, recall, delete, and/or manage their other activities in manners suitable for mobile devices. An application suite in accordance with embodiments allow users to add applications and/or to call and configure data that is most commonly used with regard to leads, quotes, service requests, and the like. Moreover, the platforms of various embodiments can use technology which allows for speed and ease-of-use including (but not limited to) photo/video compression, custom forms, and data availability via APIs (application program interfaces) for ease of client use and access.

Furthermore, because of the trust environment established, maintained, enforced, encouraged, etc. by systems of embodiments, buyers are more likely to pay a premium price for equipment listed over these systems. It is anticipated that they will value the implicit assurance that the equipment is in the condition reported in the listings of the system and/or explicit assurances. In some cases they might also be willing to pay a periodic user fee to register with the system. In addition, or in the alternative, sellers might be interested in such arrangements. Furthermore, embodiments speed the inspection of many pieces of used industrial equipment that might otherwise lay idle for months or longer awaiting their sale. All the while, of course, the owner of those pieces of equipment typically pay interest on loans associated therewith or, at least (in some cases), forego the use of capital that might otherwise have been acquired from its sale. Thus, systems of embodiments offer buyers and sellers more profitable and/or less costly operations.

Various embodiments provide servers for use in environment wherein used industrial equipment is to be advertised for sale, wherein a pre-determined number of industrial equipment types exist, wherein pieces of industrial equipment are to be one of those pre-determined industrial equipment types, and wherein the industrial equipment types have associated therewith pre-determined number of components. Some servers comprise a processor in communication with a network configured for communications with a plurality of client devices and a memory storing a file configured to contain information regarding a condition of a piece of used industrial equipment. That condition information further comprises an inspection report configured to reflect the type of industrial equipment to which the piece of used industrial equipment belongs and to further reflect the predetermined components associated with the associated industrial equipment type. Note that the client devices are configured to access the file, ascertain the type of industrial equipment, and to display the inspection report including the used condition as it relates to the piece of used industrial equipment and its pre-determined components. Servers of the current embodiment also comprise an interface configured to display the inspection report.

In some embodiments the inspection report includes a voice note recorded on a client device and/or a video related to a component of piece of used industrial equipment. Moreover, the inspection reports can be location and/or time stamped. Moreover, the client devices can comprise inspection tools configured to generate inspection reports reflecting the equipment types and to communicate the inspection reports to a server. A dealer server in communication with the network can be configured to store a plurality of used industrial equipment files wherein each of the used industrial equipment files further comprises an inspection report for a corresponding piece of used industrial equipment. If desired, one or more of the client devices can be configured to indicate a service status of a piece of used industrial equipment wherein the inspection report remains private while the service status is incomplete. In addition, or in the alternative, the inspection reports can have associated therewith indications of their trustworthiness. Related systems, client devices, methods, etc. are also provided. Such systems, servers, client devices, methods, programs, applications, etc. are available from Contact Marketing Services, Inc. of Austin, Tex.

To the accomplishment of the foregoing and related ends, certain illustrative aspects are described herein in connection with the annexed figures. These aspects are indicative of various non-limiting ways in which the disclosed subject matter may be practiced, all of which are intended to be within the scope of the disclosed subject matter. Other novel and/or nonobvious features will become apparent from the following detailed disclosure when considered in conjunction with the figures and are also within the scope of the disclosure.

### BRIEF DESCRIPTION OF THE FIGURES

The detailed description is described with reference to the accompanying figures. In the figures, the left-most digit(s) of a reference number usually corresponds to the figure in which the reference number first appears. The use of the same reference numbers in different figures usually indicates similar or identical items.

FIG. 1 illustrates a system for providing inspection information associated with used industrial equipment.

FIG. 2 illustrates a block diagram of a system for handling information associated with used industrial equipment.

FIG. 3 illustrates a method of buying/selling used industrial equipment.

FIG. 4 illustrates a graphical user interface (GUI) for inspecting used industrial equipment on a mobile device.

FIG. 5 illustrates a sign on page of a GUI for inspecting used industrial equipment on a mobile device.

FIG. 6 illustrates a listing page of a GUI for inspecting used industrial equipment on a mobile device.

FIG. 7 illustrates a new listing page of a GUI for inspecting used industrial equipment on a mobile device.

FIG. 8 illustrates a blank listing page of a GUI for inspecting used industrial equipment on a mobile device.

FIG. 9 illustrates a listing page of a GUI for inspecting used industrial equipment on a mobile device with an inspection in progress.

FIG. 10 illustrates an inspection sub-list page of a GUI for inspecting used industrial equipment on a mobile device.

FIG. 11 illustrates an inspection form page of a GUI for inspecting used industrial equipment on a mobile device.

FIG. 12 illustrates an equipment class selection page of a GUI for selecting a class during an inspection used industrial equipment on a mobile device

FIG. 13 illustrates a photograph list page of a GUI for inspecting used industrial equipment on a mobile device.

FIG. 14 illustrates a photograph capture page of a GUI for inspecting used industrial equipment on a mobile device.

FIG. 15 illustrates a photograph confirmation page of a GUI for inspecting used industrial equipment on a mobile device.

FIG. 16 illustrates a photograph viewer page of a GUI for inspecting used industrial equipment on a mobile device.

FIG. 17 illustrates a photo description page of a GUI for inspecting used industrial equipment on a mobile device.

FIG. 18 illustrates a video capture page of a GUI for inspecting used industrial equipment on a mobile device.

FIG. 19 illustrates a video conformation page of a GUI for inspecting used industrial equipment on a mobile device.

FIG. 20 illustrates a component inspection page of a GUI for inspecting used industrial equipment on a mobile device.

FIG. 21 illustrates a top-level search page of a GUI for used industrial equipment.

FIG. 22 illustrates a top-level review page of a GUI for selling used industrial equipment.

FIG. 23 illustrates a top-level inspection report review page of a GUI for selling used industrial equipment.

FIG. 24 illustrates a top-level search results page of a GUI related to marketing used industrial equipment.

FIG. 25 illustrates a component inspection report page of a GUI related to marketing used industrial equipment.

FIG. 26 illustrates a GUI of a notification center associated with marketing used industrial equipment.

FIG. 27 illustrates a GUI for one such application suite.

FIG. 28 illustrates a GUI of such an application suite.

FIG. 29 illustrates a GUI for an application suite of embodiments.

FIG. 30 illustrates a dashboard GUI for an application suite of embodiments.

FIG. 31 illustrates a dealer deals summary GUI.

FIG. 32 illustrates a GUI for a utilities application suite.

### DETAILED DESCRIPTION

This document discloses systems, apparatus, methods, etc. for providing inspection reports regarding used industrial equipment and, more particularly, for doing so in trusted environments.

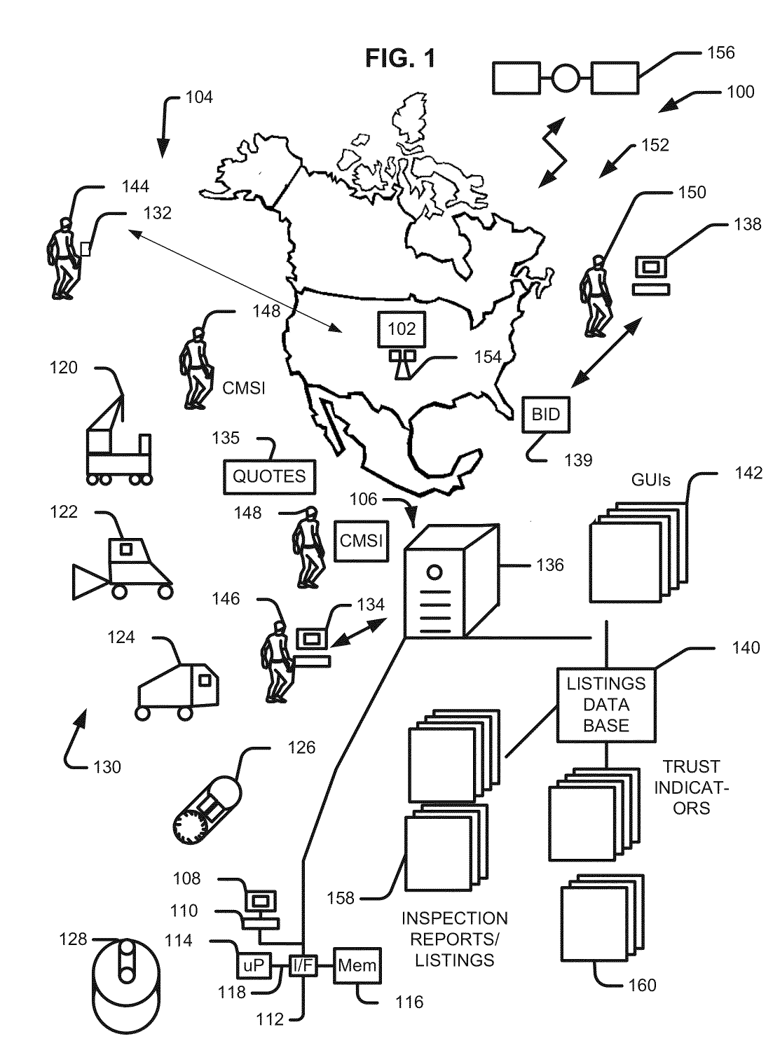

FIG. 1 illustrates a system for providing inspection information associated with used industrial equipment. Indeed, in some embodiments, the system 100 allows sellers of such equipment to arrange for inspections of their equipment; post information gathered during those inspections, and/or to receive inquiries, offers, etc. from prospective sellers via the system 100. Systems 100 can also allow buyers to browse/search for equipment meeting their desires, view the inspection reports, and/or to contact the sellers with their inquiries, bids, etc. Moreover, the system 100 provides a degree of trust (for all parties) in such transactions not heretofore available.

More specifically, FIG. 1 illustrates the system 100, a geographic area 102, a dealer 104, a computer 106, a display 108, a keyboard 110, an interface 112, a processor 114, a memory 116, a bus 118, a boom crane 120, a backhoe 122, a dump truck 124, a tunnel boring machine 126, a semiconductor crystal puller 128, pieces of industrial equipment 130, a mobile device 132, a desktop computer 134, a server 136, another mobile device 138, a database 140, GUIs 142, an inspector 144, a seller 146, an administrator 148, a buyer 150, a telecommunications system 152, a cell tower 154, a communication satellite 156, various inspection reports 158, and related trust indicators 160.

The geographic area 102 illustrated by FIG. 1 happens to be the United States of America. However, it could be any geographic area in which various sellers 146 and buyers 150 might be involved in activities related to the selling and/or buying of pieces of used industrial equipment 130. Indeed, since the industrial equipment market is an international market in at least some respects, the geographic area 102 could be any market, potentially including any number of locales, states, countries, continents, etc. Further still, since much of the information that can be conveyed by the system 100 is graphical, photographic, video, etc., language barriers related to conveying the condition of the pieces of used industrial equipment 130 can be lowered if not largely overcome.

In some situations, one or more parties using the system 100 could be a dealer 104. Such dealers 104 could be focused on buying equipment, selling equipment, or a combination thereof. Moreover, they might focus on a particular type of equipment, industry etc. As a result, they could be interested in a wide variety of used industrial equipment that might be available. FIG. 1 illustrates a sampling of the equipment which systems 100 of embodiments can be tailored to accommodate. For instance, the boom crane 120, the backhoe 122, and the dump truck 124 symbolize many types of every day construction which occurs at or near the surface of the Earth. However, the tunnel-boring machine 126 illustrates that systems 100 are not limited by industries predominately found on the surface. Rather, even mining/boring equipment can be accommodated by system 100. Furthermore, the semiconductor crystal puller 128 illustrates that high-tech and/or other industries can include, provide, etc. pieces of used industrial equipment 130 that systems 100 of embodiments accommodate. No matter the mix of equipment for sale by a particular dealer 104, that dealer could have an inventory of such equipment. Furthermore, the system 100 can provide facilities such as a virtual showroom for that dealer 104 and/or their inventory. However, systems 100 of embodiments allow buyers 150 and sellers 146 to contact each other directly thereby eliminating many “middle men” such as equipment dealers and associated expense, complexity, etc.

Even so, each type of used industrial equipment has a peculiar set of components associated with that type. For instance, many pieces of used industrial equipment 130 will have an internal combustion engine associated with it (whether that engine is an Otto Cycle, Diesel Cycle, steam, etc. engine). But, many types of used industrial equipment will have associated therewith certain components not associated with many (or all) of the other types of used industrial equipment 130. For instance, almost all backhoes 122 will have a mechanized shovel. Dump trucks 124 will have beds with hydraulic lifts while tunnel boring machines 126 will usually possess both cutting bits/teeth and/or conveyer belts for, respectively pulverizing rock and transporting the resulting rubble to transports for disposal.

Furthermore, the semiconductor crystal puller 128 illustrates that some exotic, unusual, rare, etc. types of components might be included in certain types of used industrial equipment. More specifically, the semiconductor crystal puller 128 is likely to have a specialized quartz crucible which holds molten silicon while in use. It is also likely to have some form of puller rod and/or internal wench for handling ingots, boules, etc. of silicon and/or other semiconductors. Additionally, various pieces of used industrial equipment 130 can come equipped with, or be equipped with, various accessories, after-market devices, etc. Clearly, the permutations of components that might exist for any one type of used industrial equipment is too lengthy for practicable enumeration herein. Heretofore available buy/sell, listing, and/or auction systems have been unable to accommodate these permutations. Systems 100 of embodiments can handle the permutations associated with both the numbers of types of equipment and the individual pieces of used industrial equipment 130 for which it might have to disseminate information.

FIG. 1 also illustrates that a number of computing and/or telecommunication devices might be used within systems 100 of embodiments. For instance, mobile devices 132 and 138 have found favor with many users and in many contexts as of late. These mobile devices 132 and 138 (hereinafter mobile devices 132) include but are not limited to cellular telephones, smart phones, tablets, phablets, etc. They are capable of accepting inputs from their users, receiving information from telecommunications systems 152, and display such information via GUIs (graphical user interfaces) on their displays. Because mobile devices 132 can be carried by users with little or no supporting equipment, they have found widespread acceptance in many communities and, indeed, many users wish to use them for their work-a-day and/or personal activities. System 100 leverages these desires by tailoring GUIs 142 for use on mobile devices 132 and, more specifically, self-limiting the information displayed thereon for certain pre-selected tasks associated with inspecting, buying, selling service, etc. pieces of used industrial equipment 130.

Nonetheless, and with continuing reference to FIG. 1, certain users, tasks, environments, etc. still favor the use of desktop computers 134. Accordingly, system 100 allows for the use of desktop computers 134 and/or other non-mobile computing devices. Indeed, because these desktop computers 134 often have more functionality associated therewith than mobile devices 132 and/or additional hardware/software components (for instance, larger and/or secondary displays), systems 100 can be configured to provide greater functionality, flexibility, etc. thereon. Servers 136 also typically provide increased functionality related to client-server transactions and/or Internet, intranet, WAN, and/or other types of networked connectivity and/or information exchange. Accordingly, systems 100 of embodiments assign certain tasks to servers 136 rather than other computing devices in the system 100. For instance, servers 136 of some systems 100 host databases 140 storing, organizing, making available etc. information related to the various pieces of used industrial equipment 130 in (or associated with) these systems 100. As with the mobile devices 132, the system 100 can include GUIs 142 for displaying, accepting, etc. information to/from various users.

Still with reference to FIG. 1, various users can be involved in activities associated with system 100. For instance, an inspector 144 can be involved in inspecting pieces of used industrial equipment 130. These inspectors 144 can be independent of other parties on the system 100 and can use mobile devices 132 configured to accept information pertaining to inspections of the pieces of used industrial equipment 130 which they inspect. Moreover, the system 100 can provide GUIs 142 tailored to the particular mobile devices 132 used by the inspectors 144, the types of used industrial equipment which they inspect, the sellers 146 involved, etc. The set of GUIs 142 can be correspond to a set of pre-configured reports which in turn corresponds to a set (or subset) of the available types of used industrial equipment available to the system 100. These GUIs, moreover, can present, request, make available, etc. those pieces of information desired for a particular activity and/or a particular type of used industrial equipment while limiting access to other information.

The inspectors 144, in accordance with embodiments, file inspection reports 158 in which they document the results of their inspections. These inspection reports 158 can contain a rich variety of multi media information which captures and/or conveys the condition of the pieces of used industrial equipment 130 which are the subjects of the corresponding reports. This multi media information (or rather the files containing it) can be photographic, video, audio, etc. files in many different formats. For instance, .pdf, .jpeg, mpeg, .wav, etc. formats can be used to store this information. More particularly, an inspector could snap a picture of a component of interest of a particular machine using their mobile device 132 and attach, include, or otherwise associate the resulting file with the pertinent inspection report 158. In other situations, an inspector 144 could take a video of a portion of the equipment as it is operated (again, using their mobile device 132) and incorporate it into their inspection report 158. In still other situations, an inspector 144 could record the sounds produced by a piece of used industrial equipment 130 as it operates and include it in an inspection report 158. Thus, these inspection reports 158 can convey, not only text-based information, but a great deal of multi media information regarding the condition of the equipment. And, if desired, these multi media files (and/or inspection reports 158) can have associated therewith various metadata such as comments, time stamps, location stamps, etc.

Thus, should a particular user wish to act as an inspector 144 for a semiconductor crystal puller 128, that user would find a GUI 142 prompting them for information about the crystal puller's puller rod, crucible, and the like (but not for information pertaining to a backhoe's mechanized bucket or a boom crane's winch). Of course, functionality associated with certain administrative actions could be included in such GUIs 142. For instance, the GUI 142 could provide controls for saving, editing, deleting, etc. inspection reports and/or controls for communicating with others regarding the same (for instance, interfaces to email, instant messaging, etc. systems can be provided by these GUIs).

Sellers 146 can also avail themselves of systems 100. Typically, they will do so by more powerful desktop computers 134 although this need not be the case. Some of these sellers 146 can contract with the inspectors 144 to perform the various inspections or the inspectors 144 could be contracted through other parties (such as an administrator 148). No matter what those contractual arrangements might be, the inspectors 144 (as noted elsewhere herein) produce the inspection reports 158 on their mobile devices 132. As a matter of convenience, the GUIs 142 on these devices are preconfigured to obtain information about a pre-determined set of components on each piece of equipment (based on an appropriate equipment type). Those sets of information are tailored for rapid entry on mobile devices 132 but, yet, can be supplemented. More specifically, the inspection reports can be communicated to the sellers' desktop computers 134 at which the sellers 146 can supplement the inspection reports 158 as received from the inspectors 144 (and/or their mobile devices 132). In addition, or in the alternative, the GUIs can prompt the inspectors 144 to add information about equipment options, after market add-ons, and/or unique items not listed elsewhere in the inspection report 158.

Thus, and with continuing reference to FIG. 1, the sellers 146 can review the inspection reports 158 and request and or correct discrepancies, errors and the like. In some embodiments, the system 100 restricts the ability of the sellers 146 to independently amend, alter, modify, etc. the inspection reports 158 per se. Instead, in these embodiments, the sellers 146 can report the particular issues to the inspectors 144 and/or administrators 148 for resolution. In addition, or in the alternative, the system 100 can allow the sellers 146 to add their comments, multi media files, and/or manipulate (within certain bounds) the multi media files included in the reports by the inspectors 144. For instance, systems 200 of embodiments could allow the sellers 146 to “brighten,” increase/decrease contrast, filter by color, etc. the inspectors' multi media files while limiting their ability to cut and paste, mask, otherwise distort, etc. the multi media information in the inspectors' files. Moreover, the limits and/or permissions imposed on/available to the various users (including the sellers 146) can be set by the administrators 148, etc. and/or can be determined by various criteria. For instance, some limitations/permissions can be based on the identity of the seller 146, the inspector 144, the type of equipment involved, the time frame, the location, etc. For instance, should a particular seller 146 behave in a manner contrary to the trusted environment of the system 200, administrators 148 can curtail that seller's permissions, privileges, inspection reports 158, etc. Nonetheless, at some point, of course, the system 100 allows a seller 146 to approve/finalize an inspection report 158 thereby allowing access to it by others and, more particularly, various buyers 150.

With regard to the administrators 148, they can be in a position to control the system 100 and/or, perhaps, establish, maintain, etc. an environment of trust amongst the various participating parties. Note that many of these parties (for instance, inspectors 144, sellers 146, buyers 150, etc.) might never have met each other much less dealt with each other. Further still, they might have heard of or been the victims of bad deals involving malfunctioning, damaged, or otherwise sub-par pieces of used industrial equipment 130. Accordingly, they might feel some hesitation to use a potentially far-flung system to conduct business concerning relatively large amounts of money, capital, investment, etc.

In accordance with embodiments, the system 100 can empower administrators 148 to enforce honesty, ethical behavior, accuracy, etc. in some or all of the activities fostered by the system 100. Thus, the system 100 can be configured to allow the administrators access to all information in the system 100 and that authority can be backed up by contractual permission to access the files, records, etc. of some or all parties using the system 100. Moreover, the administrators 148 can have exclusive permission/control over the trust indicators 160 associated with corresponding inspection reports 158, inspectors 144, sellers 146, and/or even buyers 150 as well as other parties. The system 100 can include features to solicit, gather, report, etc. complaints to the administrators 148 who (from that information) can conduct inquiries with the ultimate goal of setting/clearing the trust indicators 160 associated with various equipment and/or parties. These trust indicators 160 can allow others using the system 100 to gauge the trustworthiness of other parties even though they personally have no or little knowledge of these other parties. The system 100 of embodiments can therefore be configured to impose behavioral standards on users of the system 100.

Still with reference to FIG. 1, the buyers 150 can also use the system 100. More specifically, should a buyer 150 wish to find a piece of used industrial equipment to (possibly) purchase, the buyer 150 can login, create an account, login as a guest, etc. to browse/search for equipment in which they might be interested. Their mobile devices 132 and/or desktop computers 134 can be configured with a thin client optimized to present just the information that they might find useful in searching for such equipment. Systems 100 of the current embodiment allow buyers 150 to select equipment in which they might be interested and to contact the sellers 146 thereof through text messages, emails, etc. Moreover, these buyers 150 can view the trust indicators 160 associated with the piece of used industrial equipment 130, the inspectors 144, the sellers 146, etc. Thus, they can ascertain the extent to which the administrators 148 have indicated that the inspection report 158 for a given piece of used industrial equipment can be trusted to be accurate and/or complete.

Of course, as indicated by FIG. 1, much of the communications, data transfer, etc. occurring in the various activities on system 100 can occur over the telecommunications system 152. The telecommunications system 152 could be any such system capable of handling those communications. For instance, the Internet, intranets, wide area networks, etc. could be used. A POTS (plain old telephony system) could be used too/instead if desired. But, in some embodiments, the communications are routed through a cellular network and its various cell towers 154, base stations, communications satellites 156, etc. Indeed, the ability to geo-locate and/or timestamp inspection reports 158 using such telecommunications systems 152 can be helpful to various aspects of system 100 and/or its users.

Thus, system 100 of embodiments allows sellers to list their equipment and buyers to query the sellers about the same. In addition, buyers can submit bids 139 on equipment via system 100 while sellers can provide quotes 139 over system 100. In addition, system 100 can integrate with ecommerce systems so that buyers and sellers can close deals (financially) via system 100. More specifically, sellers can navigate to a particular listing, call related data to create a quotation, call the data to manage leads, and/or call the data to create a service quotation.

Still with reference to FIG. 1, a few words might be in order about the computer(s) 106, mobile devices, and/or other systems, apparatus, etc. used to perform the various activities disclosed herein. The type of computer 106 used for such purposes does not limit the scope of the disclosure but certainly includes those now known as well as those which will arise in the future. But usually, these computers 106 will include some type of display 108, keyboard 110, interface 112, processor 114, memory 116, and bus 118.

Indeed, any type of human-machine interface (as illustrated by display 108 and keyboard 110) will do so long as it allows some or all of the human interactions with the computer 106 as disclosed elsewhere herein. Similarly, the interface 112 can be a network interface card (NIC), a WiFi transceiver, an Ethernet interface, etc. allowing various components of computer 106 to communicate with each other and/or other devices. The computer 106, though, could be a stand-alone device without departing from the scope of the current disclosure.

Moreover, while FIG. 1 illustrates that the computer 106 includes a processor 114, the computer 106 might include some other type of device for performing methods disclosed herein. For instance, the computer 106 could include a microprocessor, an ASIC (Application Specific Integrated Circuit), a RISC (Reduced Instruction Set IC), a neural network, etc. instead of, or in addition, to the processor 114. Thus, the device used to perform the methods disclosed herein is not limiting.

Again with reference to FIG. 1, the memory 116 can be any type of memory currently available or that might arise in the future. For instance, the memory 116 could be a hard drive, a ROM (Read Only Memory), a RAM (Random Access Memory), flash memory, a CD (Compact Disc), etc. or a combination thereof. No matter its form, in the current embodiment, the memory 116 stores instructions which enable the processor 114 (or other device) to perform at least some of the methods disclosed herein as well as (perhaps) others. The memory 116 of the current embodiment also stores data pertaining to such methods, user inputs thereto, outputs thereof, etc. At least some of the various components of the computer 106 can communicate over any type of bus 118 enabling their operations in some or all of the methods disclosed herein. Such buses include, without limitation, SCSI (Small Computer System Interface), ISA (Industry Standard Architecture), EISA (Extended Industry Standard Architecture), etc., buses or a combination thereof. With that having been said, it might be useful to now consider some other aspects of the disclosed subject matter.

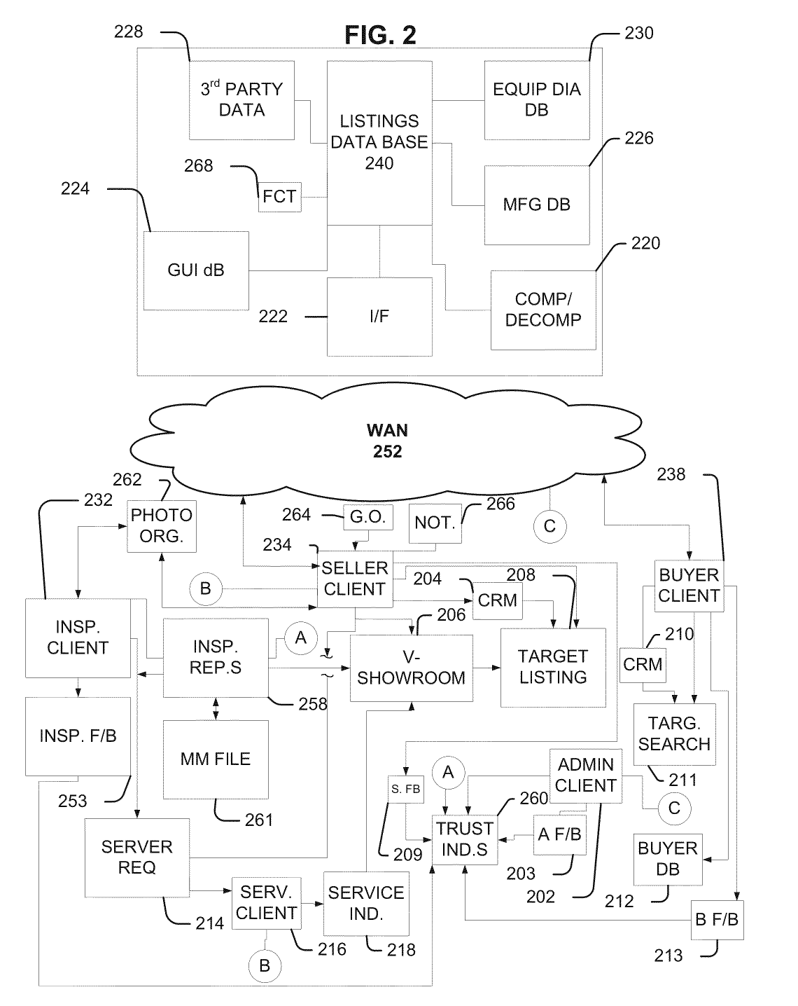

FIG. 2 illustrates a block diagram of a system for handling information associated with used industrial equipment. Generally, FIG. 2 illustrates that buyers 150 and sellers 146 can execute transactions for pieces of used industrial equipment 130 in systems 200 of embodiments which provide a level of trust not heretofore possible. Such systems 200 can be Web or Internet based to facilitate exchanging information underlying those transactions. Moreover, those communications can take advantage of thin clients, compression/decompression techniques, encryption/decryption/security techniques, and/or selective display of information to speed the transfer of information, maximize user-friendliness, etc. More specifically, FIG. 2 illustrates a seller CRM (contact relationship manager) module 204, a seller virtual showroom 206, seller targeted listings 208, a seller feedback database 209, a buyer CRM module 210, a buyer database 212, a buyer feedback database 213, service requests 214, a service center client 216, a privacy indicators 218, compression/decompression modules 220, a network interface 222, a GUI database 224, a manufacture database 226, a third party data aggregator database 228, an equipment diagnostics database 230, an inspector client 232, a seller client 234, a web server 236, a buyer client 238, a listings database 240, a wide area network (WAN) 252, inspection reports 258, an inspector feedback database 259, and trust indicators 260.

As noted elsewhere herein, systems 200 can be Web based. Accordingly, the web server 236 of embodiments can provide connectivity between the various components of these systems 200. For instance, it can host, execute, contain, store, etc. various components of the system 200 such as the compression/decompression modules 220, the network interface 222, the GUI database 224, the manufacture database 226, the third party data aggregator database 228, and/or equipment diagnostics database 230. In addition, or in the alternative, many other components of the system 200 can be hosted by the web server 236 if desired.

Nonetheless, and with continuing reference to FIG. 2, the web server 236 of embodiments hosts the listings database 240. This listings database 240 of the current embodiment stores all of the information pertinent to the various equipment listings in the system 200. For instance, it can be a repository for the administrator feedback database 203, the seller CRM module 204, the seller virtual showroom 206, the seller targeted listings 208, the seller feedback database 209, the buyer CRM module 210, the buyer database 212, the buyer feedback database 213, the service requests 214, the privacy indicators 218, the inspection reports 258, the inspector feedback database 259, and/or the trust indicators 260. These various components and/or others can be linked together in a relational database and/or stored in appropriate tables, spreadsheets, etc.

Moreover, the web server 236 can host a database of GUIs that can be used by various components throughout the system 200. Such arrangements allow for centralized control and/or coordination of the design/configuration/operation of the GUIs. Thus, an administrator 148 can control/coordinate the design of these GUIs. More specifically, the administrator 148 can design the GUIs to present just the information needed by the various users on their various devices for the tasks which they wish to accomplish on those devices. Of course, the GUIs can be configured to present additional or less information if desired without departing from the scope of the current disclosure. Moreover, in some embodiments, the GUIS are configured to allow users to swiftly execute these tasks with a succession of “taps” rather than perhaps more cumbersome text-based entry techniques.

The web server 236 of FIG. 2 can also host the manufacturers database 226. This database (in the current embodiment) can communicate with, exchange data with, etc. databases maintained by the manufacturers of the various pieces of used industrial equipment 130 which might be entered into the system 200. For instance, should a manufacturer issue a recall, safety notice, service bulletin, etc. associated with a particular piece of used industrial equipment 130 and/or a type thereof, the manufacturers database 226 can collect that information. It can also make this information available for inclusion in, association with, etc. the various inspection reports 258 resident in the system 200.

Additionally, or in the alternative, the web server 236 can host the third party data aggregator database 228. In some situations, it has occurred that third parties have found it helpful to gather data about the condition of various pieces of used equipment from those with knowledge thereof. For instance, in the context of used automobiles, CARFAX, Inc. gathers data from many service centers and provides that information to buyers, sellers, and/or other parties. To the extent that such aggregated data might be available for pieces of used industrial equipment 130, the third party data aggregator database 228 can make that information available for inclusion in, association with, etc. various inspection reports 258.

FIG. 2 also illustrates that the web server 236 can host an equipment diagnostics database 230. As the inclusion of embedded (and other types of) applications proliferate in pieces of used industrial equipment 130, much information regarding their condition is becoming available. For instance, in the aviation industries it is becoming increasingly common for manufacturers, operators, etc. to instrument their equipment and gather diagnostic data therefrom in centralized repositories. Such information can be linked into the system 200 by the equipment diagnostics database 230 of embodiments. Moreover, this database can make that information available to other components of the system 200 for inclusion in, association with, etc. the various inspection reports 258.

The web server 236 of FIG. 2 can also include the network interface 222. The network interface 222 provides connectivity/inter-compatibility between the web server 236 and the various other components with which it communicates. In addition, or in the alternative, the webserver 236 can include various compression/decompression modules 220. These modules can minimize and/or optimize the amount of digital data exchanged over the WAN 252 so that upload/download speeds are such that communications over even mobile devices are satisfactory. For instance, the multi-media files of the inspection reports 258 can appear to upload/download without user-discernible delays.

Of course, the WAN 252 can be used to tie the web server 236 to many components of the system 200 of the current embodiment. Thus, it can communicate with the web server 236 and/or its various hosted components via the network interface 222. The WAN 252 can be the Internet, a portion thereof, the World Wide Web, an intranet, or any other telecommunications network capable of handling the communications/data exchanges disclosed herein as well, perhaps, others. Furthermore, the WAN 252 of embodiments also communicates with the inspector clients 232, the seller clients 234, the administrator clients 202, the buyer clients 238, and/or other entities as disclosed elsewhere herein.

FIG. 2 illustrates these other entities as being separate from the web server 236 and/or the WAN 252 although other configurations are within the scope of the current embodiment. For instance, the administrator client 202 could be hosted on the web server 236. At this juncture, and with continued reference to FIG. 2, it might now be helpful to consider these other entities in further detail.

The current embodiment includes a plurality of inspector clients 232 resident on a corresponding number of mobile devices 138. The inspector clients 232 provide a variety of capabilities for the inspectors 144. For instance, they can integrate the capabilities of the mobile devices 132 operated by the inspectors 144 into the system 200 of the current embodiment. The inspector clients 232 also display the GUIs used to inspect equipment including entering certain textual information (if desired), and a series of tap controls for selecting discreet, list-driven, etc. information into the inspection reports. For instance, these GUIs can be pre-configured for particular types of used industrial equipment. The GUIs could be ordered to walk the inspectors 144 through a list of components for that type of equipment and to tap to select a value for the condition for each component so presented.

For instance, if an inspector 144 were inspecting a backhoe, the inspector 144 could navigate through a series of GUIs reflecting a hierarchy of equipment types. That hierarchy might begin with a list of industries such as construction, mining, semiconductor, aviation, etc. The inspector 144 could select construction by tapping on it, thereby resulting in another level of the hierarchy being displayed for construction equipment. One selection at that level might be earth movers, the selection of which would then cause the inspector client 232 to display a list of earthmoving equipment: bull dozers, graders, back hoes, excavators, etc. From that display, the inspector 144 could choose backhoes (again, by pointing and tapping).

In addition, or in the alternative, a report shell for the particular type of equipment could be pre-loaded into the inspector client 232 responsive to a request to the system 200 by a seller 146 to do so. That request could identify the piece of equipment (by for instance, manufacturer, model number, serial number, inventory number, location, etc.). Thus, when the report shell loads into the inspector client 232, much identifying information could already be populating the inspection report 258. The GUI thereon could present this information to the inspector 144 and/or allow them a chance to confirm, correct, augment, etc. the identifying information before advancing to the first of the actual component-related GUIs (as disclosed further herein).

The inspector client 232 could cause a GUI to appear that corresponds to the first backhoe component on the list of components. That component-related GUI would likely name/identify the component and have a list of possible condition values ranging from, for instance, new down to unsalvageable. In addition, or in the alternative, that GUI could have tap-able controls for taking a photo, a video, an audio recording, or some other type of multi-media information capture. Accordingly, in accordance with the current embodiment, the inspector 144 would select a value for the condition of the component and/or tap a control to initiate the multi-media capture of information about the component (and/or its condition). The inspector client 232 would then enter the condition into the inspection report and associate it with the component corresponding to that GUI. Additionally, the inspector client 232 could associate the resulting multimedia file 261 resulting from the capture with that component.

Furthermore, the inspector client 232 could be configured to advance the display to the GUI for the next component in, perhaps, a pre-configured, sequential list of components. The process could then repeat until the inspector 144 completes the inspection. If desired, the client inspector 232 could be configured to time, date, and/or location stamp the inspection report 258 at some point during the inspection. Moreover, the inspector client 232 could leverage inherent time keeping and/or geo-locating capabilities of the mobile device 132 used by the inspector 144 to prepare the inspection report 258. From there, the inspector client 232 could compress the multi-media files and transmit the report (along with the multimedia files) to the web server 236 for inclusion in the listing database 240.

Moreover, the system could include a forms configuration tool 268. The forms configuration tool 268 of embodiments is designed to automatically generate inspection report forms including building the various portions thereof. Many of these forms will have more than one section. For instance, such forms such as one or identifying the piece of equipment to be associated with a particular inspection report 158 and/or one for identifying the location and the equipment components. Additionally, these forms can include a condition report form. Of course, the forms configuration toll 268 of the current embodiment can provide the controls and/or other GUI elements on these forms. If desired, the forms configuration tool 268 can communicate with various manufacturing databases 226 to import bills of materials for various types, makes, models, etc. of used industrial equipment. The forms configuration tool 268 of embodiments can use these sources of information and/or others to import components lists for inclusion (in either in whole or in part) in the inspection reports 158.

Further, the system 200 can also include a photograph organizer 262. It can communicate with and/or is part of the inspector client 232 and/or seller client 234. In the current embodiment, it organizes the photographs associated with the equipment and/or its components. The photograph organizer 262 of the current embodiment also maintains the correspondence between the sequential order of the components and photographs thereof as listed in the various inspection reports. Thus, it can assist buyers by ensuring that the appropriate photograph (or multimedia file) is associated with each component inspection report. Also, for those GUIs which display the inspection reports and/or listings, the photograph organizer 262 of the current embodiment walks through each named photograph position so that each equipment-lister (inspection report) for a given type of equipment follows the same sequence. Embodiments of the photographic organizer 262 can be associated with the administrator client 202 and/or the buyer client 238.

FIG. 2 also illustrates seller clients 234. Seller clients 234 of embodiments enable several types of activities by the sellers 146 on their desktop computers 134 (and/or other computing devices). For instance, seller clients 234 can allow the sellers 146 to access/modify inspection reports 258 associated with their equipment, manage their virtual showroom 206, access their CRM module 204, initiate listings, create targeted listings 208, interact with the inspectors 144 (via the inspector clients 232), interact with buyers 150 (through the buyer clients 238), and to initiate service requests 214. Again, the seller clients 234 of the current embodiment can leverage inherent capabilities of the desktop computers 134 on which they often reside.

With continuing reference to FIG. 2, the seller client 234 can allow sellers 146 to manage their virtual showrooms 206. This type of activity can include initiating inspections and/or inspection reports 258, accessing them, reviewing, them, modifying them (within pre-set limits), augmenting them, and/or approving them. GUIs can be provided with the seller clients 234 to facilitate these activities and many of these GUIs can be predominately tap driven interfaces. Once an inspection report 258 receives approval from the seller 146, the seller client 234 can cause a listing to be generated and/or transform the inspection report 258 to a listing. However, the seller client 234 can allow the seller 146 to control whether that listing is published, held privately, etc.

FIG. 2 also illustrates that seller clients 234 of the current embodiment can enable the sellers 146 to manage their CRMs. More specifically, seller clients 234 can allow a seller 146 to select a listing and select a potential buyer or a list or group of buyers 150 and create a listing targeted to just those buyers 150. Thus, seller clients 234 can allow sellers 146 to create targeted listings 208. At a time selected by the seller 146, the seller client 234 can publish the targeted listing 208 to the selected buyers 150. Again the GUIs presented to the sellers 146 during such activities can be predominately tap driven.

In addition, or in the alternative, a seller 146 might find it desirable to initiate a service request 214 after viewing a particular inspection report 258. Seller clients 234 can be configured to assist with such activities and related activities. For instance, a series of pre-dominantly tap driven GUIs can walk a seller 146 through the process of creating a service request 214. The seller client 234 can be configured to associate the underlying inspection report 258 with the service request 214 and to cause a privacy indicator 218 to be associated therewith set to indicate that the report/listing involved should remain private. Once the service request 214 is satisfied, as controlled via the seller client 234, that privacy indicator 218 can be cleared allowing system 200 to publish the listing/report if desired.

The seller client 232 can have associated therewith a group organizer 264. The group organizer 264 can allow users to manage groups of user to whom they send targeted listings and/or other communications. For instance, a user could use the group organizer 264 to create a new group and to populate with their contracts from their CRM 204 or otherwise. In some cases, furthermore, the user might know or suspect that a particular group of their contacts is interested in a particular type of equipment. They might, therefore, create a group of these users via the group organizer 264 and send selected messages, listings, etc. to them via the group.

In other scenarios, the user could create a broadcast group for various listings. Indeed, if the user wishes to run a “special” or comes across an item in high demand, they can target a message to the members of a corresponding group. The message can include a link to the listing and/or other information pertinent thereto. The group organizer 264 of embodiments thereby eliminates or reduces the number of telephone calls, emails, etc. associated with such listings.

In some embodiments the seller client 234 also has associated therewith a notification center 266. The notification center 266 of embodiments maintains a summary of all notifications that the seller received for a given period of time (such as a day, a week, a month, etc.) The summary can include hyperlink to the corresponding listings, inspection reports, etc. The notification center 266 can also maintain a summary of all leads, quotes, sales, etc. associated with the seller. Of course, the inspector client 232, administrator client 202, and/or buyer client 238 can have associated therewith a group organizer 264 and/or notification center 266. It might now be helpful to consider some aspects of administrator clients 202.

Buyer clients 238 of embodiments, furthermore, enable buyers 150 to use system 200. More specifically, buyer clients 238 allow buyers 150 to search for pieces of used industrial equipment 130, to access the inspection reports 258, and to manager their contacts via their CRM MODULE 210 among other activities. The buyer client 238 illustrated by FIG. 2 also builds a database of the searches, their results, the inspection reports 258, listings, bids, etc. associated with the buyer 150 who uses it. Thus, the buyer client 238 allows the buyer 150 access to the records/data associated with their shopping on system 200. Moreover, the GUIs associated with the buyer client 238 (which is resident on the buyer's mobile device 138 and/or other computing devices) can be configured to allow the buyers 150 to tap their way through the various activities.

For instance, these GUIs can be arranged in an industry/equipment hierarchy reflecting that of the GUIs associated with the seller client 234. Thus, the buyer client 238 could present a top level GUI to the buyer 150 and receive therefrom a selection of a given industry from a drop down list, series of buttons, etc. Note that the buyer client 238 could have features allowing the buyer 150 to restrict their searches to particular sellers/inspectors selected via CRM MODULE 210. Moreover, the buyer client 238 could be configured to guide the buyer 150 through the hierarchy until the buyer 150 reaches the type of equipment in which they might have an interest. The available (and published) listings along with their inspection reports 258 can then be accessed by the buyer 150 by pointing and tapping at icons, photos, etc. associated with the various pieces of used industrial equipment 130. They can then walk through the ratings, multimedia files, textual information, etc. associated with each (or some) of the components of the piece of used industrial equipment 130 which is the subject of the selected inspection report 158 and/or listing.

Further still, and with continuing reference to FIG. 2, the buyer client 238 GUI could include controls for contacting the seller 146 for that piece of equipment. The GUI can allow the buyer 150 to tap on controls for each of a number of ways of contacting the seller 146. For instance, there could be individual controls for emailing, texting, calling, instant messaging, etc. the seller 146. Furthermore, the system 200 could then establish that contact between the buyer client 238 and the corresponding seller client 234. From there, the parties can proceed to negotiate a deal, close the deal, finance the deal, arrange for delivery of the equipment, etc. independently of the system 200.

Administrator clients 202 of embodiments allow administrators 148 to configure, start up, run, maintain, modify, etc. the system 200 as well as to insert, interject, etc. themselves into various activities occurring in the system 200. Indeed, one type of activity that administrators 148 might be interested in is providing, enforcing, policing, etc. an environment of trust for the system 200 and its users. Thus, should a particular inspector 144, seller 146, buyer 148, and/or other parties act in ways detrimental to the ability of various users to trust the system 200, the inspection reports 258, listings, searches, and/or other users, the administrators 148 can investigate, limit, suspend, block, revoke, etc. their activities.

For instance, the administrator client 202 could generate user surveys 209, 213, and/or 259 at particular times. In some cases, the administrator client 202 could be configured to send a (potential) buyer 150 a buyer survey 259 after each search, listing/inspection report viewing, (attempted) seller contact, negotiation, purchase, delivery, etc. That buyer survey 259 could question the buyer 150 about the veracity of the inspection report 258 and/or the activities of the inspector 144 and/or seller 146 associated with the underlying piece of used industrial equipment 130. The administrator client 202 could be configured to send corresponding seller surveys 209 to the sellers 146 (and/or inspectors 144) in addition or in the alternative. These surveys 209 and/or 213 could question these users about the behavior of the other users.

As user surveys 209, 213, and/or 253 are returned they can be stored in the listings database 240 and associated with the parties, the listings, inspection reports 258, etc. involved. Moreover, the user surveys 209, 213, and/or 253 and/or collection thereof can be screened, studied, data-mined, etc. for patterns and/or specific occurrences which might merit follow up by the administrators 148. Thus, ethical parties can be rewarded and less than ethical parties can be identified and dealt with accordingly. At this juncture, it might be helpful to consider how system 200 operates.

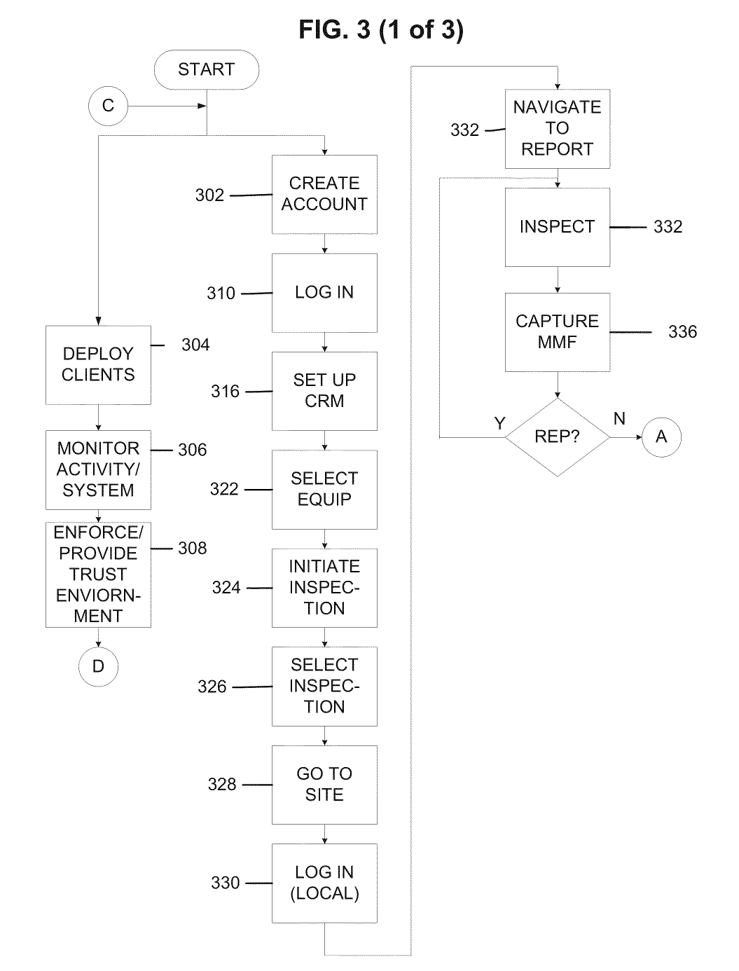

FIG. 3 illustrates a method of buying/selling used industrial equipment. Generally, the method 300 includes actions by inspectors 144, sellers 146, and buyers 150 conducted with the aid of and/or on a system 200. At reference 302, the various parties can create accounts on the system 200. In accordance with the current embodiment, the web server 236 can deploy inspector, seller, buyer, etc. clients (respectively 232, 234, and 238) including the various GUIs to the mobile devices 132, desktop computers 134, and/or other computing devices used and/or specified by the various parties. See reference 304. Moreover, the administrator client 202 can begin monitoring the various activities, users, listings, etc. on the system 200 (and the system 200 itself and its components) to determine whether corrective action might need to be taken. See reference 306. More specifically, the administrator client 202 can begin issuing user surveys 259, 209, 213, etc. to determine whether the various users are acting in trustworthy manners and whether the various inspection reports 258 and/or listings are accurate and complete (see reference 308). Such activities can be ongoing throughout method 300.

Of course, at some point, a user with an account can log into the system 200 to engage in activities related to inspecting, selling, and/or buying pieces of used industrial equipment 130. For instance, a seller 146 can log into the system 200 to initiate an inspection of a piece of used industrial equipment 130 (see reference 310). If this is the first time that the user has logged in or if the user other wise wishes to set up/manage their CRM MODULE 210, they can do so at reference 316. Otherwise, in the current scenario, the seller 146 selects a piece of used industrial equipment 130 for which they wish to use system 200 to market. See reference 322. This piece of used industrial equipment 130 might be on a dealer's lot, at the seller's facility, etc. or it could be located remotely from the seller 146. In some situations, it might be so far from the seller 146, that the seller 146 has little or no practicable way in which to inspect the equipment.

Thus, the seller 146 could initiate an inspection as indicated at reference 324 using their seller client 234. As part of that request, the seller 146 could specify that a particular inspector 144 be used for the inspection. See reference 326. Of course, if the seller 146 does not specify a particular inspector 144, the system 200 can be configured to automatically select an appropriate inspector 144. In most situations, the seller client 234 will send the partially populated inspection report 258 to the inspector client 232 of the appropriate inspector 144.

Upon receipt of the inspection report (or at some other time), the selected inspector 144 will go to the location of the piece of used industrial equipment 130 with their mobile device 132. See reference 328. If their mobile device 132 is not on, they can turn it on and log in to their account as indicated at reference 330. They can then navigate to the partially populated inspection report 258 and/or its top-level page. See reference 332. Note that the report could have been sent to them attached to an email or as a hyperlink embedded in an email, text message, etc. In accordance with the current embodiment, the inspector 144 can then begin the inspection. For instance, they can verify that the piece of used used industrial equipment 130 which they have been asked to inspect is indeed that piece of equipment by, for instance, verifying its identifying information in the inspection report 158. The inspector 144 can also time/date and/or location stamp the inspection report 258. Moreover, they can take a photograph, video, audio recording of the equipment (whether running or not) so as to capture an overall multi-media impression of the equipment and associate it with the inspection report 258. When they so desire, they can then tap to a button or other control on their GUI to begin the component-by-component inspection. See reference 334.

For instance, suppose they have been called upon in method 300 to inspect a forklift. They could begin by inspecting the hoses, an area of concern for many would-be-buyers 150. The GUI displayed by the inspector client 232 could offer several controls, each with a choice for the rating of the hoses: new, good, fair, poor, failed, etc. Or the ratings could be on a numeric scale such as a 1-10 scale, 10 being the best condition. No matter the rating scale/terms used, the inspector 144 can tap the rating which they feel that the hoses merit. Moreover, responsive there to, the inspector client 232 can present another page of the GUI prompting the inspector 144 to capture one or more multimedia files 261 of the hoses. The GUI can provide buttons or other controls prompting the user to specify whether the file is to capture video, audio, etc. information or, perhaps, none. When the inspector 144 makes their choice, the inspector client 232 can use the inherent capabilities of the mobile device 132 to capture the appropriate type of file. For instance, it can call on the operating system of the mobile device 132 to activate the onboard camera, microphone, etc. and to capture the file. See reference 336.

Once the multimedia file 261 is captured, the inspector client 232 can then present another page on the GUI prompting the inspector 144 to inspect the next component. For instance, the inspection report 258 could be structured so that the next component to be inspected would be the forks of the forklift. In the current scenario, the inspection report 258 might next call for inspection of the mast, the lift cylinder, backrest, tilt cylinder, drive wheels, steering/rear wheels, counter weight, operators seat, lights, horn, engine, etc. in some pre-configured order. Note that captured multimedia files 261 of the inspection of some components could add a richness to the inspection report 258 heretofore not available. For instance, brief instructions could be included on the GUI for the inspections of motors which would call for the engine to be started cold and with an audio/video file being captured as it starts. In such ways, remote buyers 150 could hear not only how the engine runs, but how it runs cold, under load, unloaded, etc. Of course, the inspection could continue until the last component receives its inspection. See reference 338.

If desired, the inspector client 232 could be configured to automatically finalize the inspection report 258 after the inspection of the last component. In some embodiments, though, the inspector client 232 is configured to allow the inspector 144 to review the report and/or make modifications as desired. For instance, the GUI could replay the inspection (along with the multimedia files) component-by-component with tap controls prompting the inspector 144 to change the ratings, remove files, add new files, etc. See reference 340.

Moreover, the inspector client 232, the web server 236, the listings database 240, etc. could be configured to, at some point, request/retrieve data about the piece of used industrial equipment 130 from third party sources. For instance, the listing database 240 could retrieve data from various third party data aggregators (for instance, CARFAX® for used vehicles). In the alternative, or in addition, the inspector client 232 could retrieve data from an onboard equipment diagnostics database 230 of the piece of used industrial equipment 130. The latter being performed, perhaps, via a WiFi, USB, etc. link between the mobile device 132 and the piece of used industrial equipment 130. Another possible action could be for the listings database 240 to, at some point, retrieve data about the equipment from a manufacturer database 226 of information maintained buy the manufacturer, dealer, seller, etc. of the equipment. Some or all of this data could then be summarized and/or associated with the inspection report 258. See reference 342.

With continuing reference to FIG. 3, method 300 can continue with the inspector client 232, the listings database 240, or some other entity sending the inspection report 258 to the requesting seller 146 via system 200 and/or over the WAN 252, telecommunications system 152, the Internet, etc. Note that compression/decompression modules 2220 could be used at various points to reduce the amount of data transmitted/received, to speed upload/download times, etc. Appropriate security techniques could be employed too such as password encryption, SSL (secure socket layer), TLS (transport layer security), HTTPS (hypertext transfer protocol secure), etc. See reference 344.

Thus, system 200 of embodiments allows the seller 146 an opportunity to review the inspection report 258, its multimedia files, any third party data associated therewith, etc. (see reference 346). Moreover, depending on the configuration of the system 200, the inspection report 258, the seller client 234, etc. the seller client 234 can be permitted some freedom to modify, alter, correct, etc. the inspection report 258 and/or its multimedia files. For instance, the seller 146 could be permitted to add comments to the inspection report but not to alter the component ratings. In some scenarios, the seller 146 could be permitted to remove a multimedia file 261 but not to add one or to crop, edit, shorten, etc. it. In other scenarios, the seller 146 could (with the approval of an administrator) be allowed to modify the inspection report 258. However, in some embodiments, the seller 146 would only be allowed to request that the inspector 144 or administrator 148 modify the inspection report 258. See reference 347.

In accordance with embodiments, method 300 continues at reference 348 after the seller 146 reviews/modifies the inspection report 258. More specifically, the seller 146 might decide that the piece of used industrial equipment might call for some service. The hoses of the forklift, for instance, might be in such a shape that the seller 146 (having seen the multimedia file 261 of them) might want to have them replaced. Accordingly, the seller 146 could generate a service request 214 via the GUI of the seller client 234. Furthermore, the seller client 234 could be configured to associate the inspection report 258 with the service request 214 and to send both files to a service center and/or system (not shown). The seller client 234 can also allow the seller 146 to set a privacy indicator 218 associated with the inspection report 258 and/or piece of used industrial equipment 130. See references 350 and/or 352.

Once the service is complete (for instance, the hoses are replaced) at reference 354, the seller 146 could if desired have a partial (or complete) re-inspection performed. Note that various inspections can be performed and/or followed up with inspections by independent inspectors 144. At some point though, the seller 146 can (through the seller client 234) indicate that the service is complete and/or clear the privacy indicator 218. See reference 356 respectively. Thus, while the equipment was being serviced the inspection report 258 could have been held in confidence by the system 200. With the inspection report 258 approved by the seller 146 and the privacy indicator 218 cleared, the system 200 can be configured to allow the inspection report 258 to publish. In some embodiments, the system 200 sets/clears the privacy indicators 218 responsive to the generation/satisfaction of the service request 214.

With continuing reference to FIG. 3, method 300 can include the seller 146 placing the piece of used industrial equipment 130 in a virtual showroom 206 (see reference 358). Thus, the equipment can be featured, shown passively, etc. in the virtual showroom 206 of a dealer or other seller. Moreover, the seller 146 can market the piece of used industrial equipment 130 in a variety of other ways. For instance, the seller client 234 can be configured to allow the seller 146 to select (using their CRM module 204) a pre-selected group of potential buyers 150, individual buyers 150, dealers, re-sellers, and/or other users for a targeted listing 208 of the piece of used industrial equipment 130. Thus, the system 200 can be configured to send a notification of the targeted listing 208 to these users and/or it can send them the associated listing and/or a link to it to via text messages, emails, instant messaging, etc. (see reference 360)

Of course, potential buyers 150 can use their buyer client 238 to search for pieces of used industrial equipment 130. They can also, of course, rely (in part or completely) on targeted listings 208 to find equipment if they so desire. More specifically, they can navigate to a search page of the GUI of their mobile device 132 (or other computing device) and (by pointing and tapping) navigate to and/or through the hierarchy of equipment associated with the system 200. Once they reach a desired type of equipment, their GUI can allow them to specify pre-selected groups of sellers 146, individual sellers, dealers, re-sellers, etc. with which to focus their search. In the alternative, or in addition, the GUI can be configured to allow them to select equipment ratings, component ratings, etc. with which to focus their search. Thus, the buyers 150 can perform a general, or more focused, search for used equipment. See reference 362.

Still with reference to FIG. 3, the buyer client 238 can be configured to send the resulting search request to the web server 236 of embodiments. Responsive thereto, the web server 236 can search the listings database 240 and return the results thereof to the buyer client 238. Moreover, the buyer client 238 can be configured to display icons, buttons, thumbnails, etc. corresponding to one or more of the pieces of used industrial equipment 130 on the GUI of the mobile device 132 of the buyer 150. Thus, as indicated at reference 366, the buyer 150 can browse the results of their search. The GUI, moreover, can be configured to display the inspection report 258 for equipment which the buyer 150 selected by pointing and tapping at the control associated therewith. The buyer can therefore navigate through the inspection report 258, its multimedia files, third party data, etc. Moreover, the GUI can be configured with a control to allow the buyer 150 to select a piece of equipment and/or place it on a “favorites,” “likes,” “interested in,” etc. folder. See reference 368.

Further still, the GUI of the buyer client 238 can be further configured with a control allowing the buyer 150 to initiate contact with the seller 146 of the equipment. See reference 370. That contact can be made through the system 200 via text messages, emails, instant messages, chat rooms, etc. or it can be made independently of system 200. Moreover, the buyer 150 and seller 146 can negotiate via the system 200 and/or by other means as illustrated at reference 372. In many cases, the buyer 150 and seller 146 can close the deal, again, with or without reliance on the system 200 as illustrated by reference 374. Part of the closing, of course, can be arranging for payment, delivery and/or receipt of the equipment (see references 378 and 380 respectively) having never met in person and/or either one having visited the particular piece of used industrial equipment 130 if desired. Further still, the buyer 150 (or some party acting on their behalf) can place the equipment in use and/or begin operating it. See reference 382. Again, these activities can be facilitated by the trusted environment provided by systems 200 of embodiments.

As indicated elsewhere herein, the administrator client 202 can be configured to send user surveys 209, 213, and/or 259 to the various parties using, registered with, signed on to, etc. the system 200 (see reference 384). Furthermore, the administrator client 202 can receive the returned surveys 209, 213, and/or 259 at reference 386 and data mine them for trustworthy, suspect, untrustworthy, etc. behavior. And, should some data from the user surveys 209, 213, and/or 259 so indicate, the administrator client 202 can be configured to take some sort of remedial action. For instance, it could send the administrator 148 a report, indication, message, etc. about the potential issue which it found. Or, the administrative client could intervene in the system 200 to restrict the privileges, activities, inspection reports 258, listings, etc. associated with a user whose behavior might be concerning to other parties on the system 200. Of course, the administrator client 202 could be configured to query the user who might have triggered the concern. In the alternative, or in addition, the administrator client 202 could prompt the administrator 148 to take some form of remedial action as indicated at reference 388. Moreover, method 300 can repeat in whole or in part as indicate at reference 390.

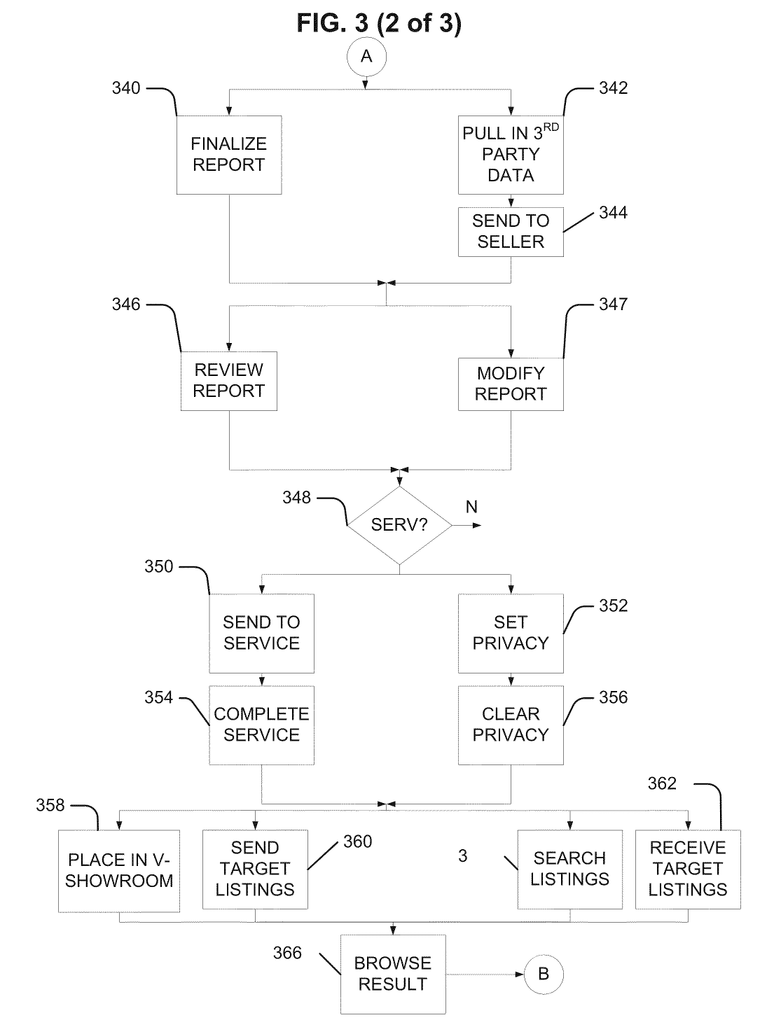

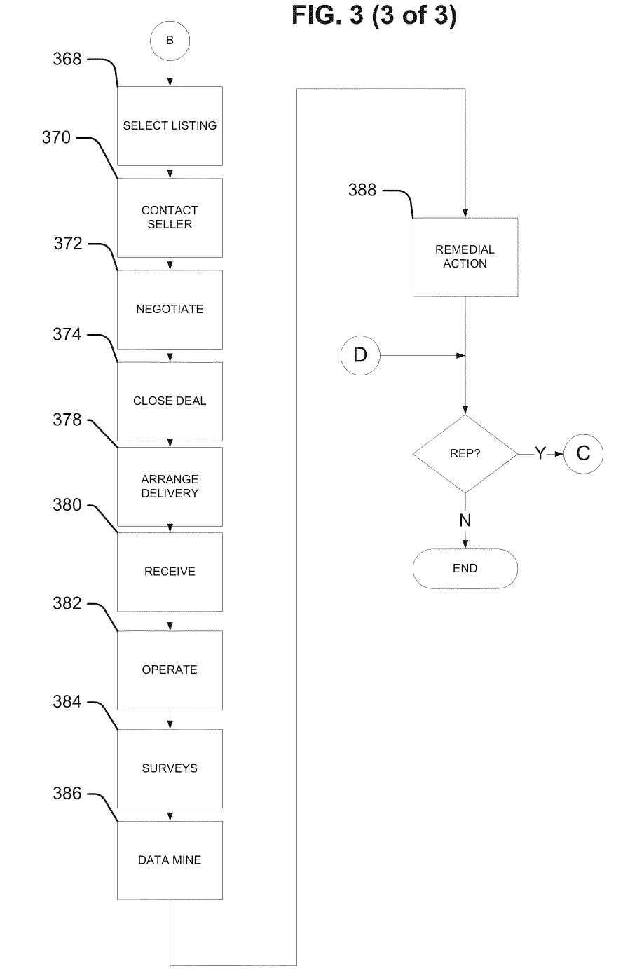

FIG. 4 illustrates a graphical user interface (GUI) for inspecting used industrial equipment on a mobile device. Generally, FIG. 4 shows a hierarchy of various pages of the GUI 400 designed in accordance with embodiments. The GUI 400 allows users of a mobile device to add new inspection reports and fill in, modify, edit, etc. new inspection reports. More specifically, the GUI 400 of the current embodiment includes numerous pages 402, 404, 406, 408, 410, 412, 414, 416, 418, 420, 422, 424, 426, 428, 430, 432, and 434. It also illustrates various paths between the pages 402, 404, 406, 408, 410, 412, 414, 416, 418, 420, 422, 424, 426, 428, 430, 432, and 434 over which users can navigate as they inspect used pieces of industrial equipment 130 and/or at other times. FIG. 5 illustrates a sign on page of the GUI 400.

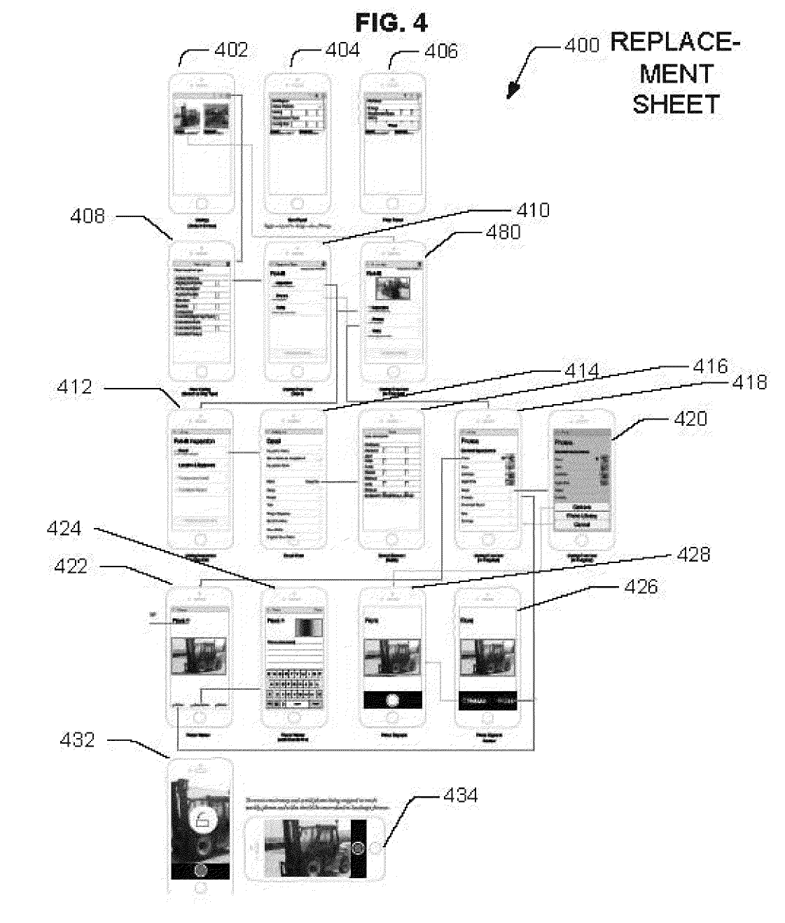

FIG. 6 illustrates a listing page of a GUI for inspecting used industrial equipment on a mobile device. The listing page 402 includes numerous thumbnails, icons, controls, etc. each representing a listing 600. Users can tap on particular listings to access subsequent pages in the GUI 400.

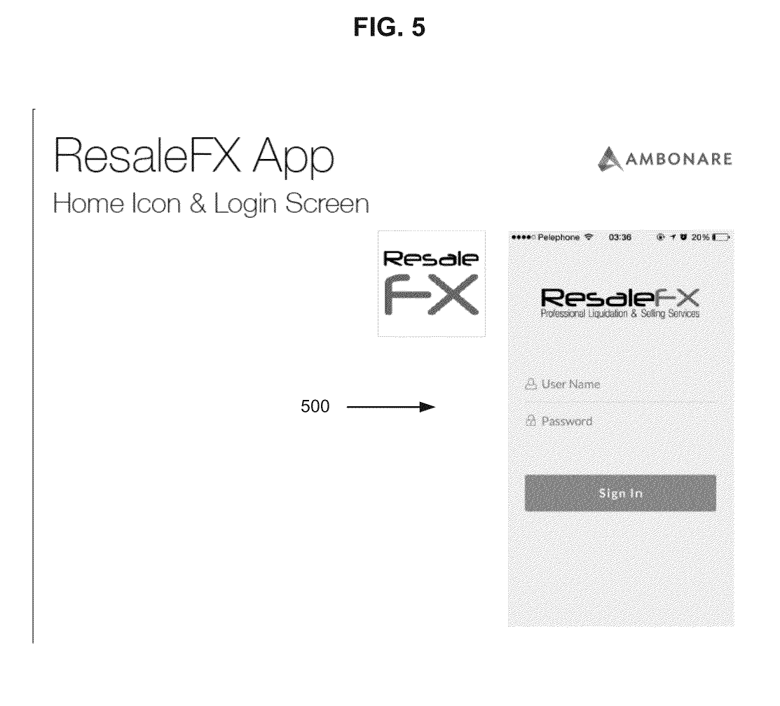

FIG. 7 illustrates a new listing page of a GUI for inspecting used industrial equipment on a mobile device. The new listing page 408 displays a list 700 with potentially numerous controls 702 each corresponding to a type of industrial equipment for which the GUI 400 is configured.

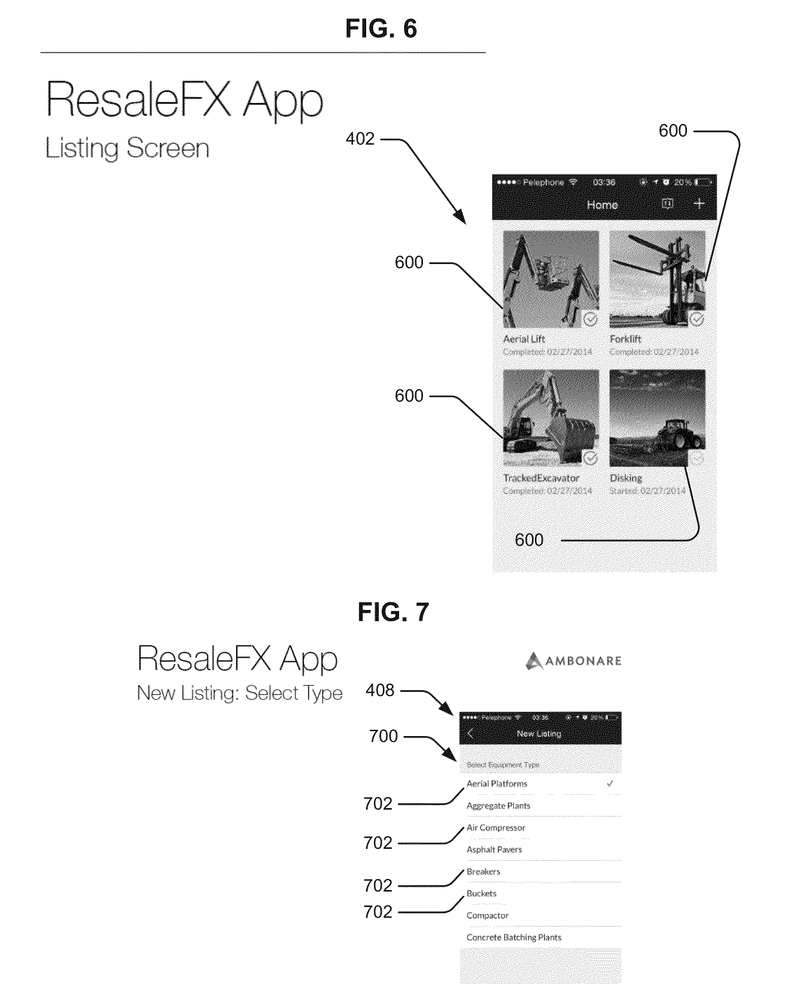

FIG. 8 illustrates a blank listing page of a GUI for inspecting used industrial equipment on a mobile device. The blank listing page 410 displays controls 802, 804, and/or 806 allowing a user to navigate to, respectively, inspection, photograph, and/or video sections of an inspection report. In some embodiments, the sections are progressively enabled on completion of previous sections. It also happens to be the last page of the inspection report on the inspector's device of the current embodiment.

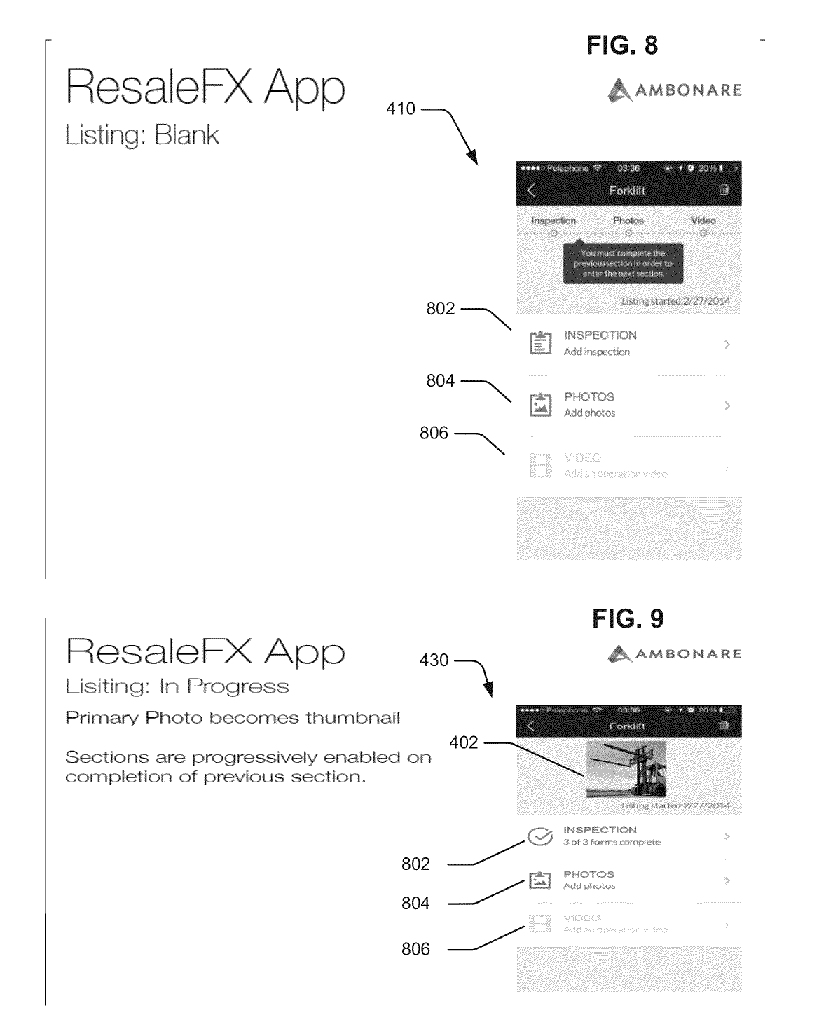

FIG. 9 illustrates a listing page of a GUI for inspecting used industrial equipment on a mobile device with an inspection in progress. The listing page 430 displays (in addition to the controls 802, 804, and/or 806) a thumbnail of a primary photograph 902 for the used piece of industrial equipment 130 that is being inspected (or for which an inspection has been requested).

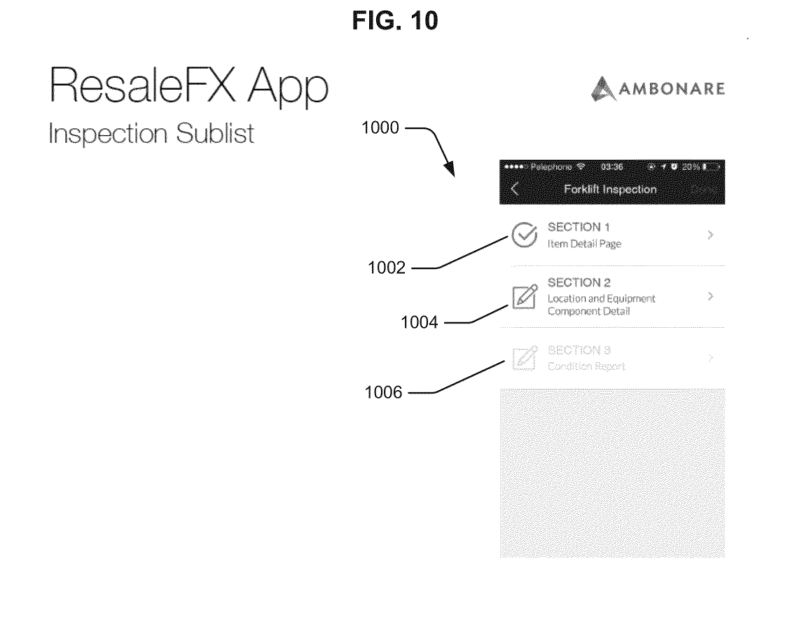

FIG. 10 illustrates an inspection sub-list page of a GUI for inspecting used industrial equipment on a mobile device. The sub-list page 1000 includes controls 1002, 1004, and/or 1006 allowing users to navigate between corresponding sections of an inspection report. For instance, control 1002 could allow the user to navigate to an item detail page of an inspection report while control 1004 could allow the user to navigate to a location and equipment component detail page of an inspection report. Additionally, or in the alternative, control 1006 could allow the user to navigate to a condition report page of an inspection report. It also happens to be the first page of the inspection report on the inspector's device of the current embodiment.

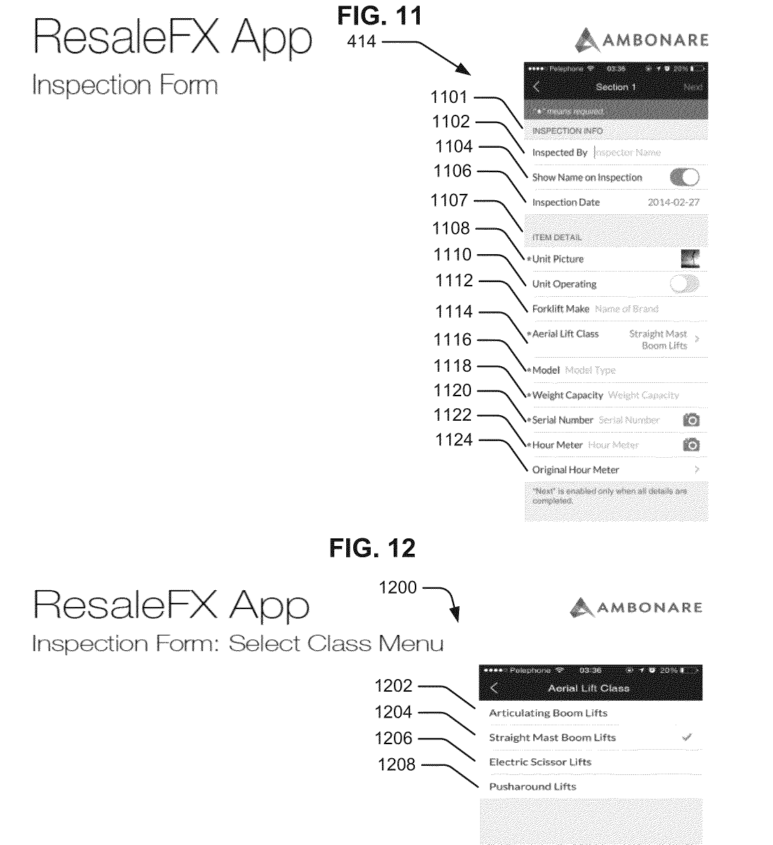

FIG. 11 illustrates an inspection form page of a GUI for inspecting used industrial equipment on a mobile device. The inspection form page 414 includes a number of controls and/or other GUI components 1101, 1102, 1104, 1106, 1107, 1108, 1110, 1112, 1114, 1116, and 1118. In the case of elements 1101 and 1107, they label, define, etc. inspection information and item detail sections, respectively, of the inspection form page 414. Meanwhile, controls 1126 and 1128 allow users to navigate to, respectively, the next page of the inspection form and the previous page of the inspection report. In some embodiments, the next control 1126 is enabled only after all inspection information called for on the inspection form page 414 has been entered. The Table 1 lists such information for an illustrative type of equipment, a forklift. This page also happens to be the page on which an inspector begins inspection reports on the inspector's device of the current embodiment.

TABLE 1

| | |
|---|---|
| Inspected By | 1102 |
| Show Name on Inspection (Y/N) | 1104 |
| Inspection Date | 1106 |
| Unit Picture | 1108 |
| Unit Operating (/N) | 1110 |
| Make of Equipment (Brand Name) | 1112 |
| Subclass of Equipment | 1114 |
| Model | 1116 |
| Weight or Other Capacity | 1118 |
| Serial Number | 1120 |
| Hour Meter, Mileage, etc. | 1122 |
| Original Hour Meter | 1124 |

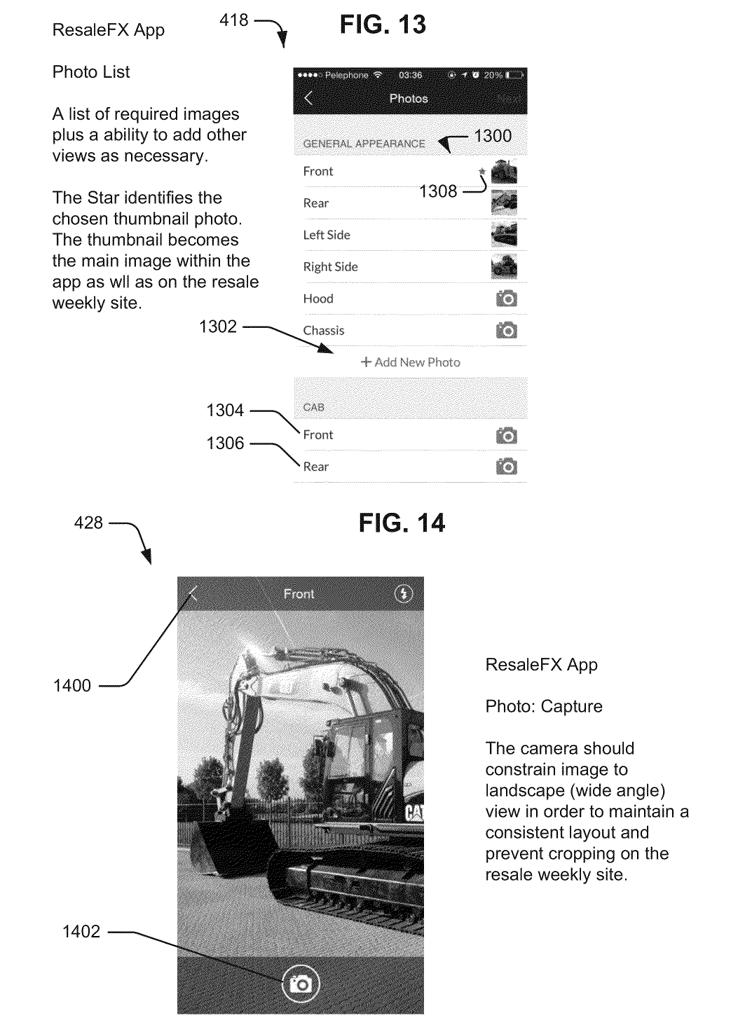

FIG. 12 illustrates an equipment class selection page of a GUI for selecting a class during an inspection used industrial equipment on a mobile device. The equipment class selection page 1200 of the current embodiment allows users to select from various classes, sub-classes, etc. of industrial equipment to which the used piece of industrial equipment 130 belongs. For instance, for illustrative purposes, the equipment class selection page 1200 lists classes of aerial lifts and controls 1202, 1204, 1206, and/or 1208 for selecting articulating booms, straight mast booms, electric scissor lists, and/or pusharound lifts.

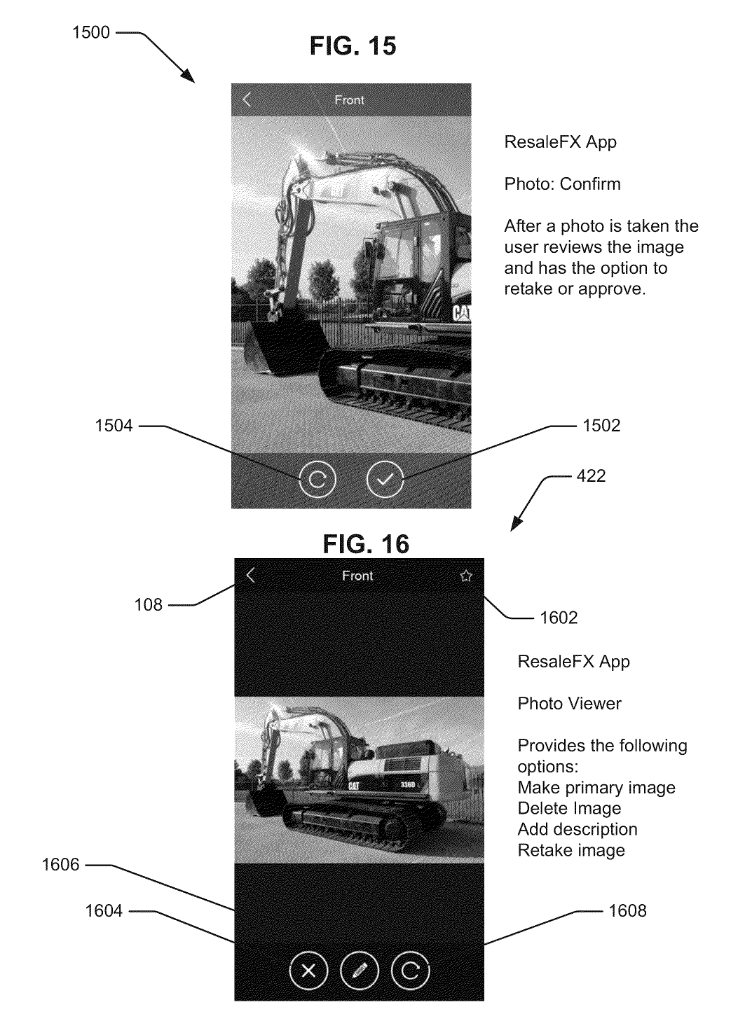

FIG. 13 illustrates a photograph list page of a GUI for inspecting used industrial equipment on a mobile device. Generally, the photograph list page 418 displays a list 1300 of photographs, images, videos, and/or other multimedia files to capture during the inspection. The photograph list page 418 also allows users to view, hear, access, etc. these files. The photograph list page 418 also includes a control 1302 for adding new multimedia files to the inspection report and controls 1304 and 1306 for two such additional files. Additionally, or in the alternative, an indicator 1308 can show which photograph (or other file) is to be the primary photograph for the inspection report. In some cases, a series of corresponding controls can allow users to change the selection of the primary photographs. That selection can be fixed for the life of the inspection report listing in accordance with embodiments.

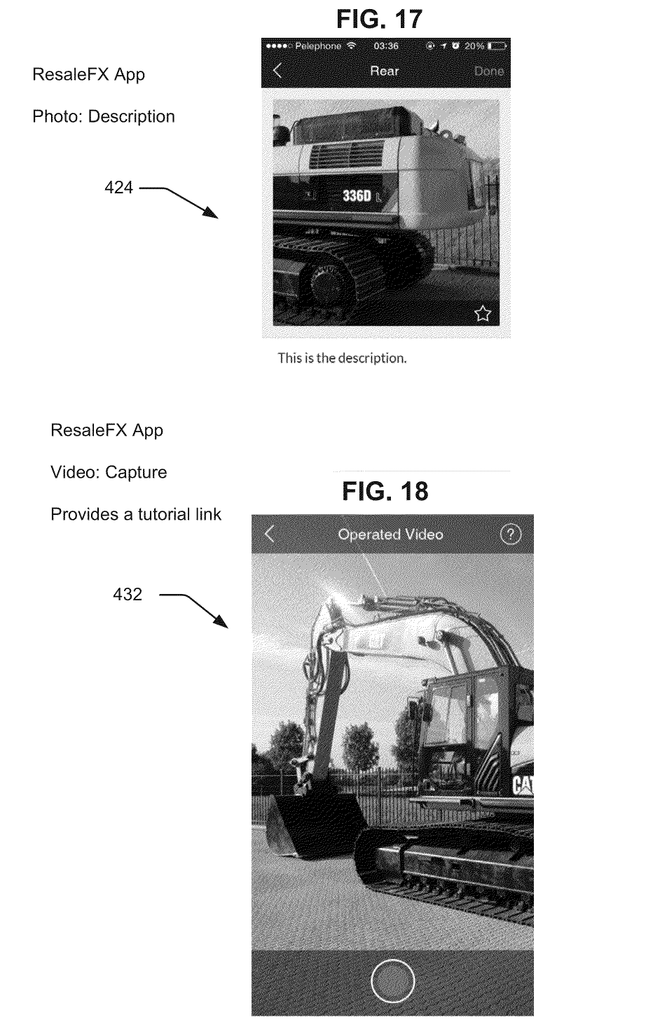

FIG. 14 illustrates a photograph capture page of a GUI for inspecting used industrial equipment on a mobile device. The photograph capture page 428 of the current embodiment can display the scene (including the equipment being inspected) at which the mobile device (or rather its camera) is pointed. It can also include a control 1402 for initiating/pausing/terminating etc. the image capture. It can also include a control 1404 allowing users to navigate back to other sections/pages of the inspection report.

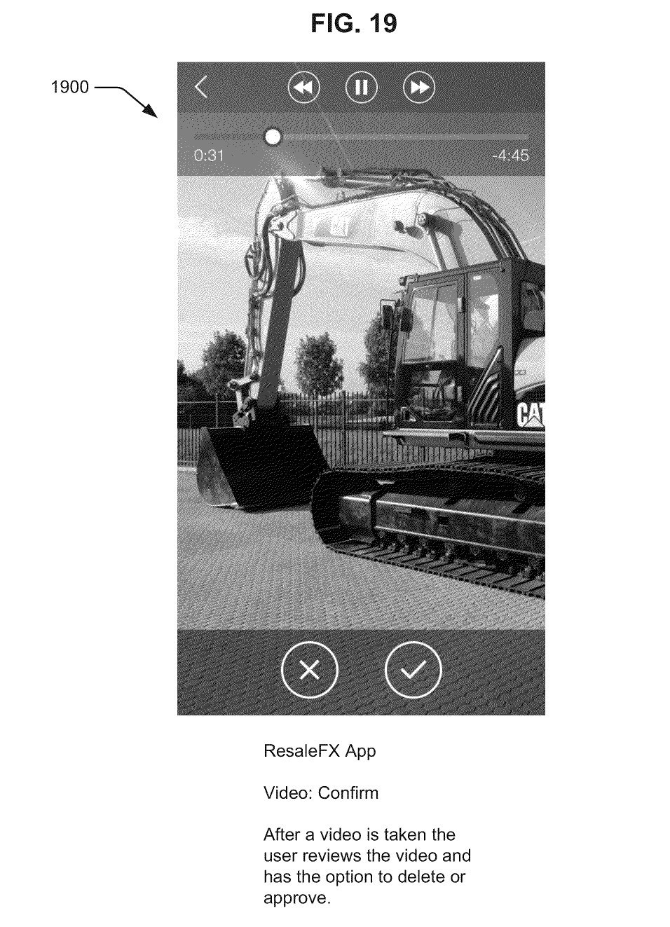

FIG. 15 illustrates a photograph confirmation page of a GUI for inspecting used industrial equipment on a mobile device. The photographic confirmation page 1500 allows users to confirm whether they wish to confirm a photograph or reject it and obtain another via controls 1502 and 15024 respectively. Thus, users (after having captured an image) can review the photograph and retake it or approve it.

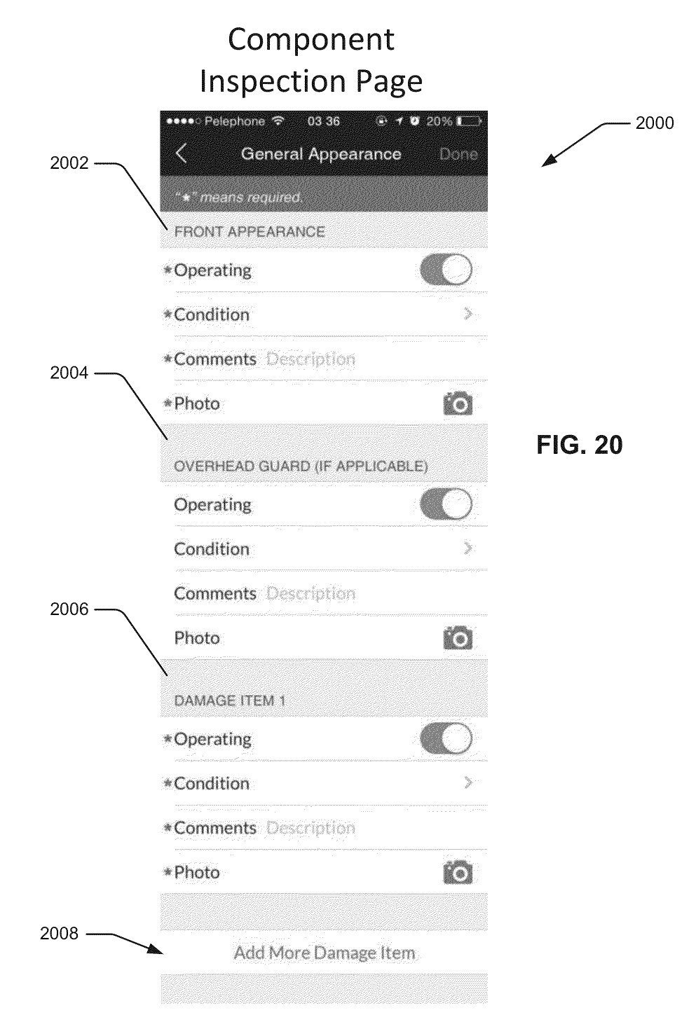

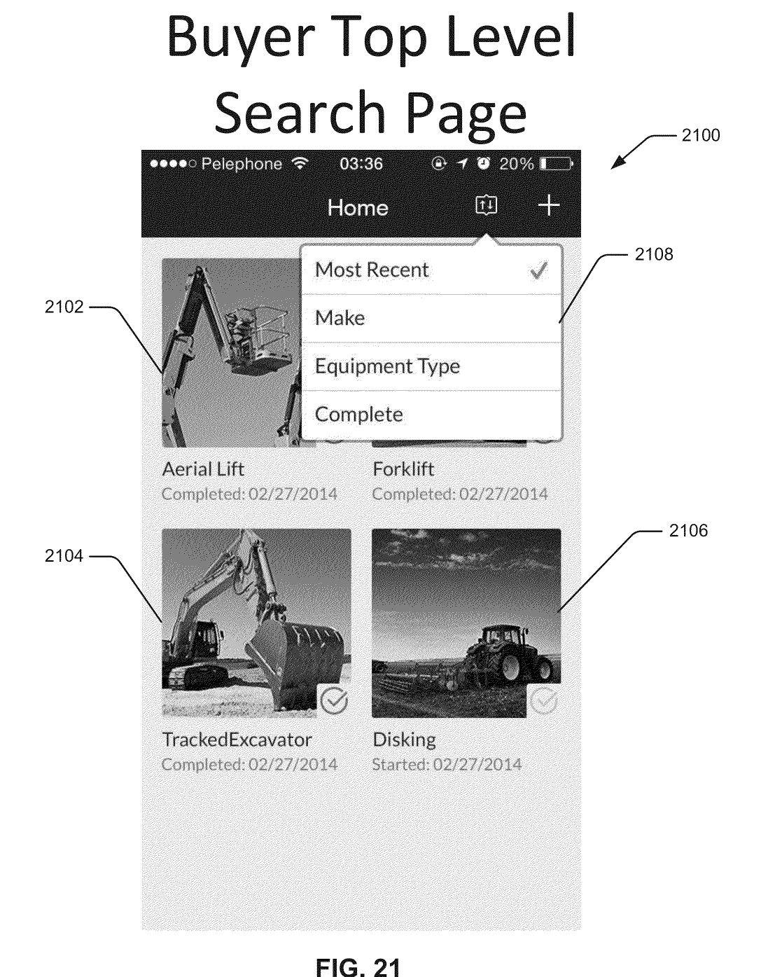

FIG. 16 illustrates a photograph viewer page of a GUI for inspecting used industrial equipment on a mobile device. The photograph viewer page 422 allows user to view captured photographs one at a time. It also includes controls 1602, 1604, 1606, 1608 and/or 1610 which, respectively allow users to make the photograph the primary photograph for the current inspection report; delete the photograph; add a description to the photograph; and/or retake the photograph. FIG. 17 illustrates a photo description page of a GUI for inspecting used industrial equipment on a mobile device. The photograph description page 424 displays photographs in the inspection reports one at a time along with their descriptions.

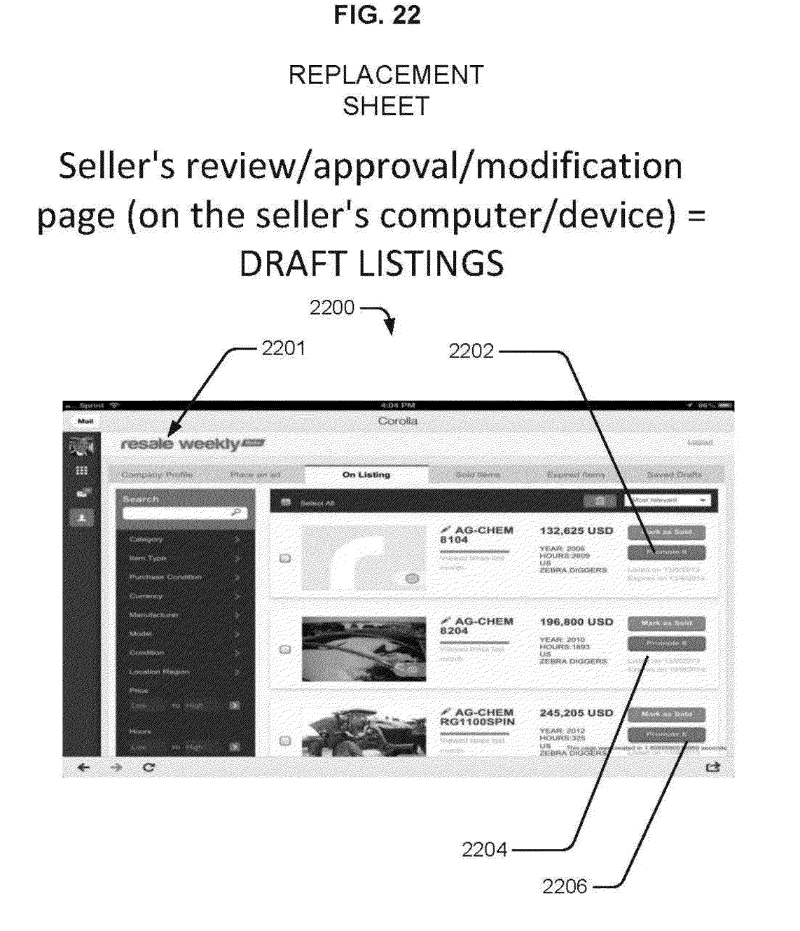

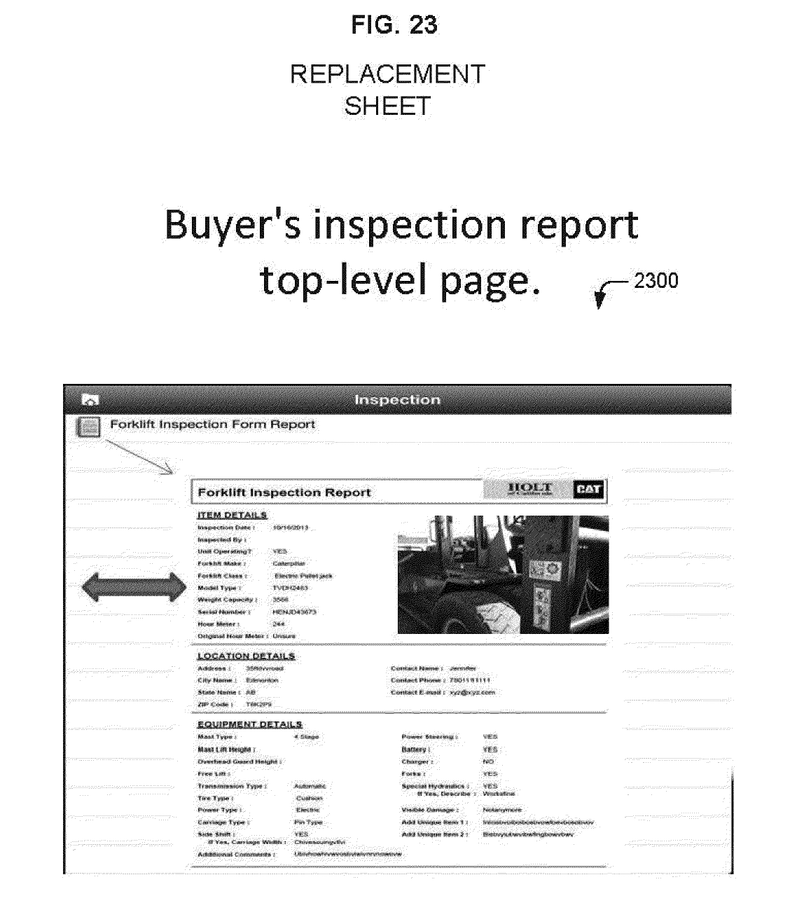

FIG. 18 illustrates a video capture page of a GUI for inspecting used industrial equipment on a mobile device. In some embodiments, the video capture page 432 in some respects it is similar to the photograph capture page 428 except that it works in conjunction with videos, video captures, etc. FIG. 19 illustrates a video conformation page of a GUI for inspecting used industrial equipment on a mobile device. In some embodiments, the video confirmation page 1900 in some respects is similar to the photograph confirmation page 1500 except it works in conjunction with videos, video captures, etc.

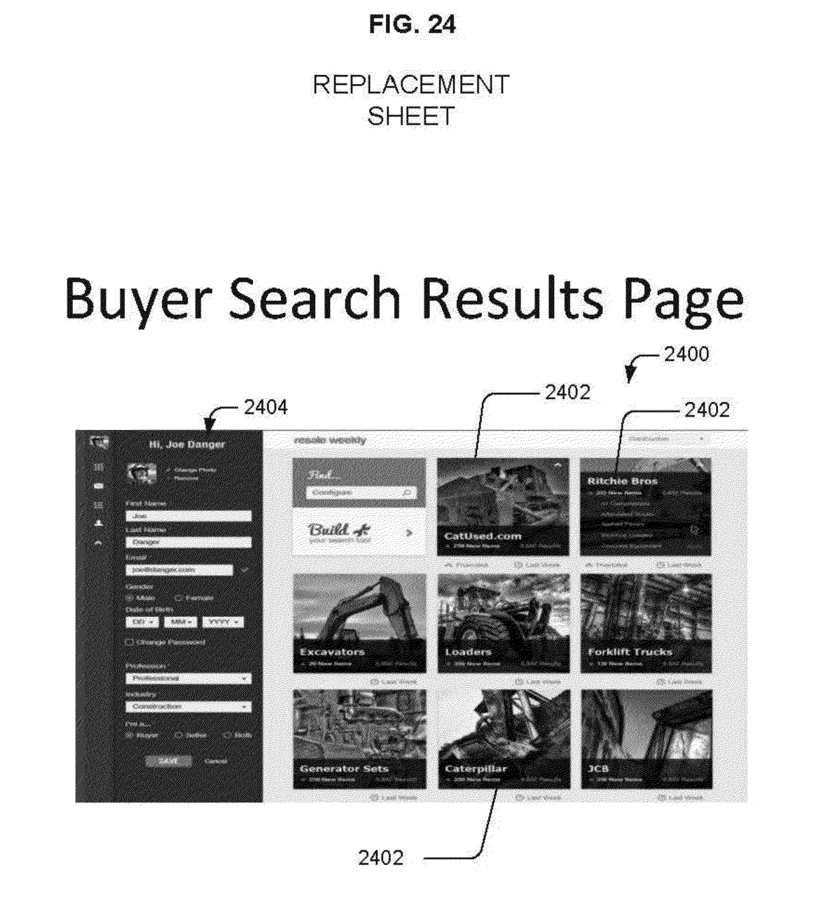

FIG. 20 illustrates a component inspection page of a GUI for inspecting used industrial equipment on a mobile device. The component inspection page 2000 includes two particular GUI elements 2002 and 2004 providing controls, fields, etc. allowing users to enter information about particular components. Another GUI element 2006 allows users to enter information regarding a damaged component. Yet another GUI element allows users to create another GUI element for entering information about another damaged component (if any are present).

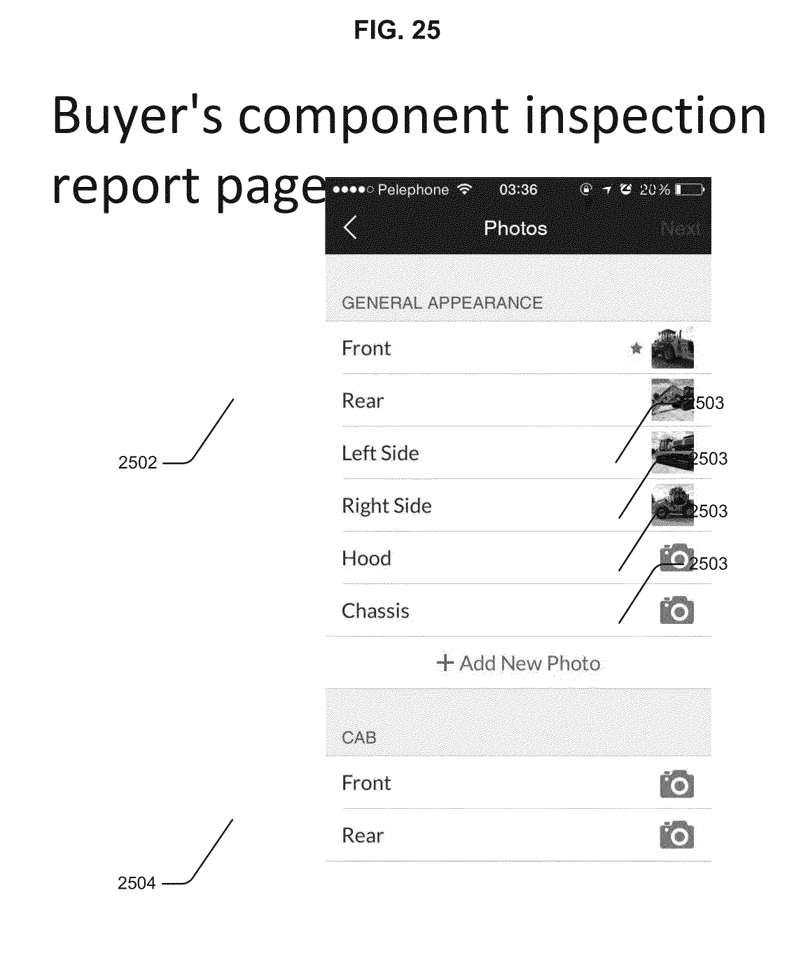

FIG. 21 illustrates a top-level search page of a GUI for used industrial equipment. The top-level search page 2100 includes a number of GUI elements some of which allow users to select the type of equipment which they wish to search for. For instance, see GUI elements 2102, 2104, and 2106. GUI element 2108, on the other hand, allows users to select criteria on which to search such as repeating their most recent search, searching on a particular make (s), searching on a particular equipment type(s), whether the inspection report is complete, etc.

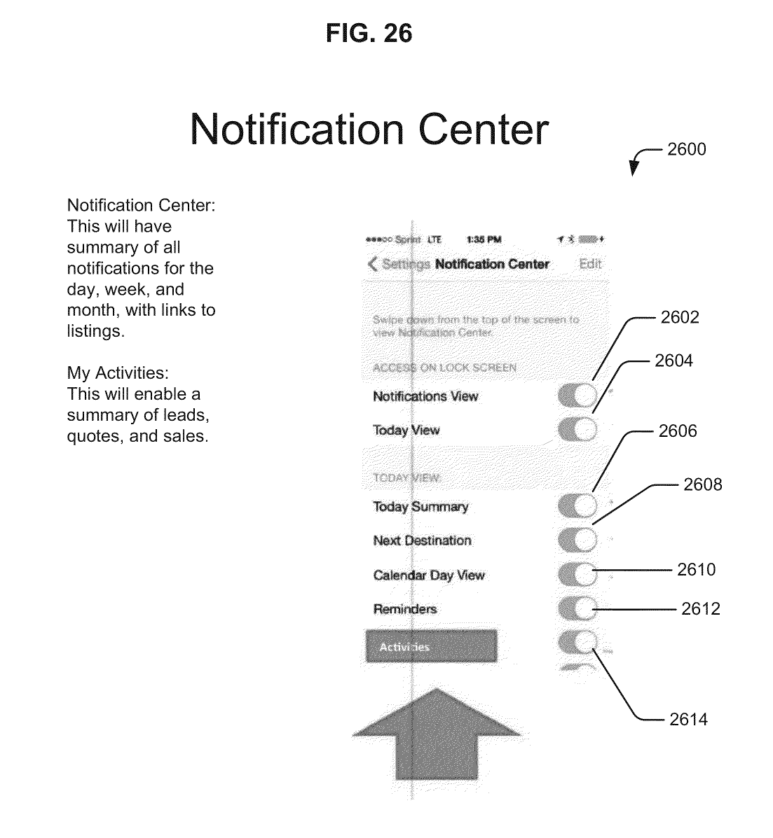

FIG. 22 illustrates a top-level review page of a GUI for selling used industrial equipment. Users who are selling equipment can use the top-level review page to search for inspection reports for (sub) sets of their inventory of equipment. Indeed, the top-level review page 2200 can include search features 2201 for initiating such searches. The top-level review page 2200 of the current embodiment also includes a number of GUI elements 2202, 2204, and 2206 identifying particular used pieces of industrial equipment 130 in the seller's inventory. These GUI elements can allow users to click, tap, or otherwise select them responsive to which the underlying inspection reports can be presented.

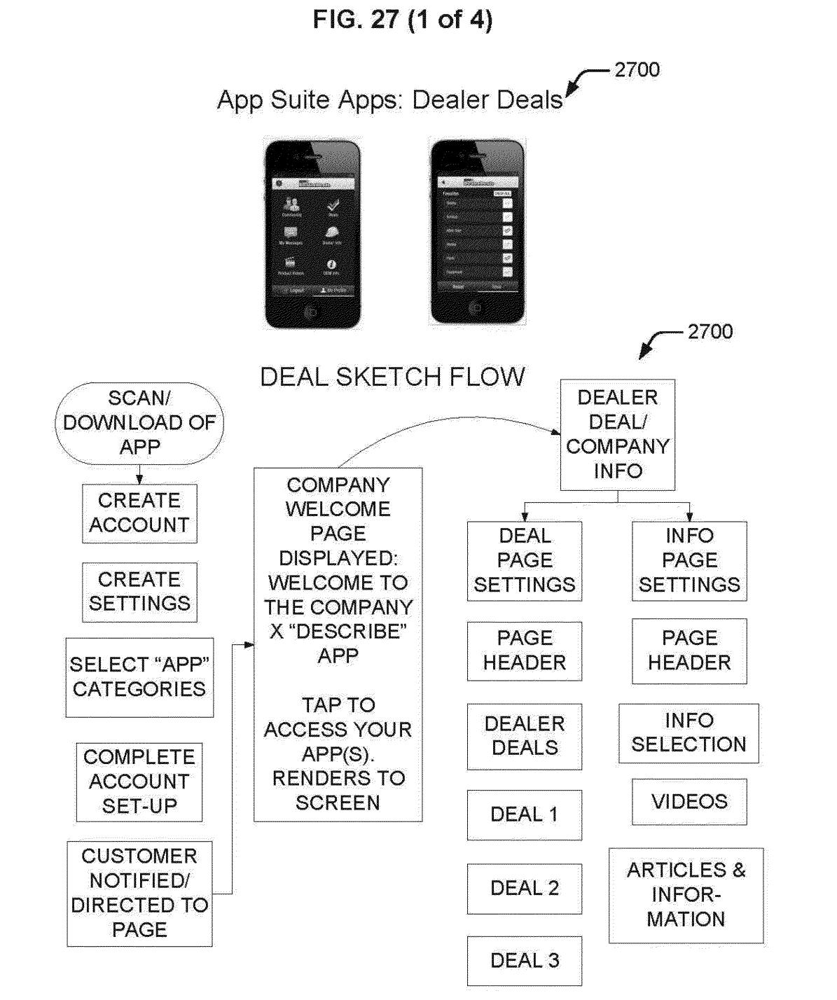

FIG. 23 illustrates a top-level inspection report review page of a GUI for selling used industrial equipment. The top-level inspection report form 2300 illustrated by FIG. 23 displays top-level information pertaining to the inspection and/or the underlying equipment. It can include controls allowing users to navigate to more detail/component oriented pages.

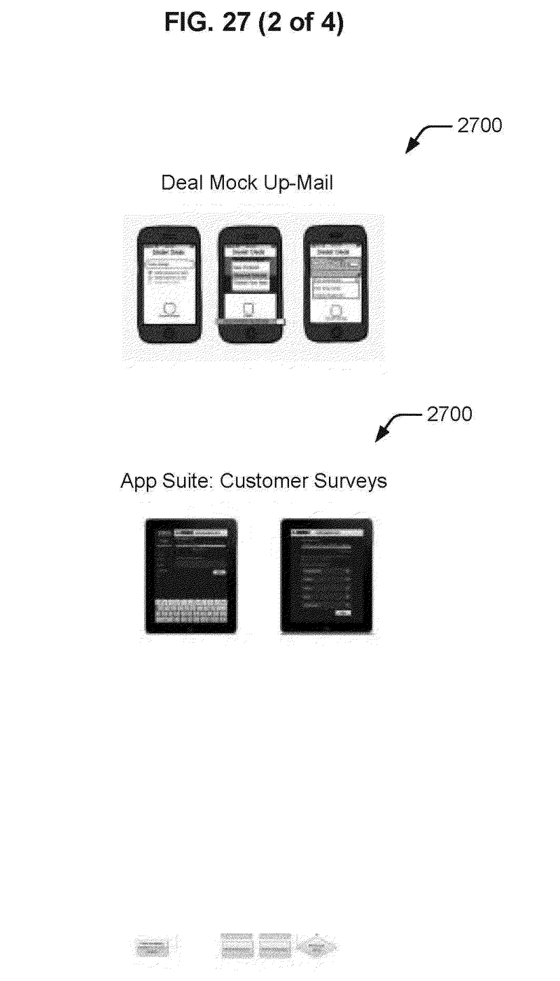

FIG. 24 illustrates a top-level search results page of a GUI related to marketing used industrial equipment. The top-level search results page 2400 displays a number of thumbnails 2402, icons, etc. showing the primary pictures of the equipment listings returned by their search. The page also includes a GUI element 2404 which allows the user to self-identify with information regarding their interests, status, demographics, etc. This information can be forwarded to a seller of a piece of equipment in which the user might be interested.

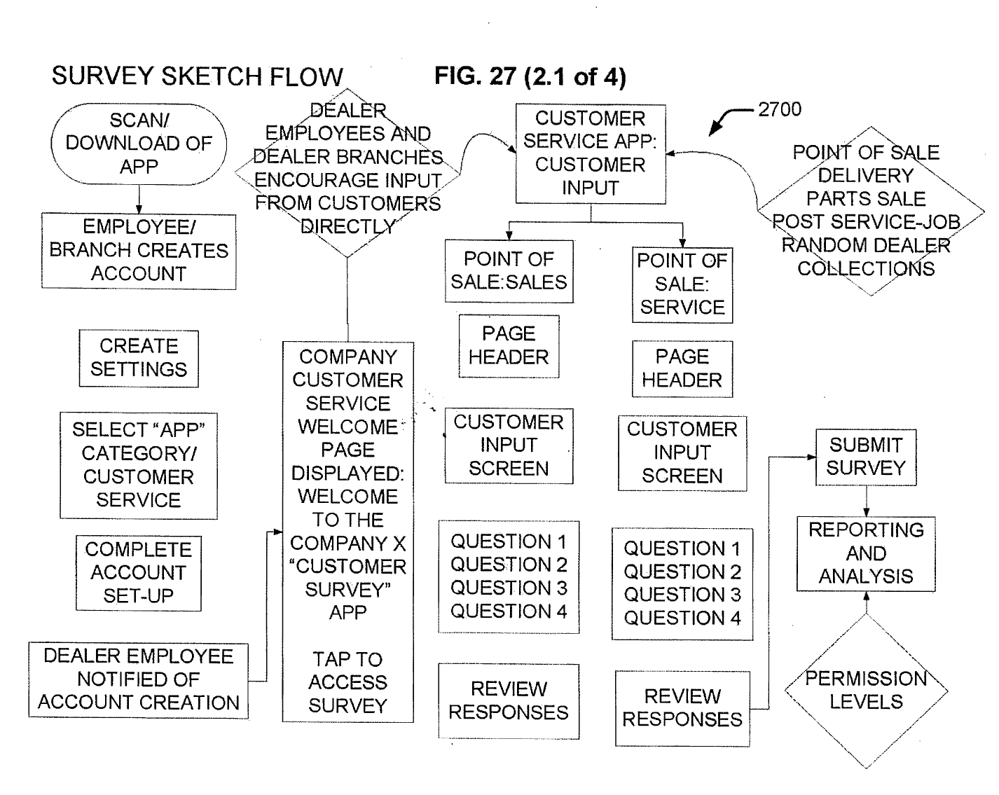

FIG. 25 illustrates a component inspection report page of a GUI related to marketing used industrial equipment. The component inspection report page 2500 can be displayed on a buyer's computing device after they have navigated to a particular listing. It includes a GUI element 2502 with controls allowing them to view the photos taken of that piece of equipment. It also includes a GUI element 2504 with similar controls allowing buyers to view any additional photos taken during the inspection.

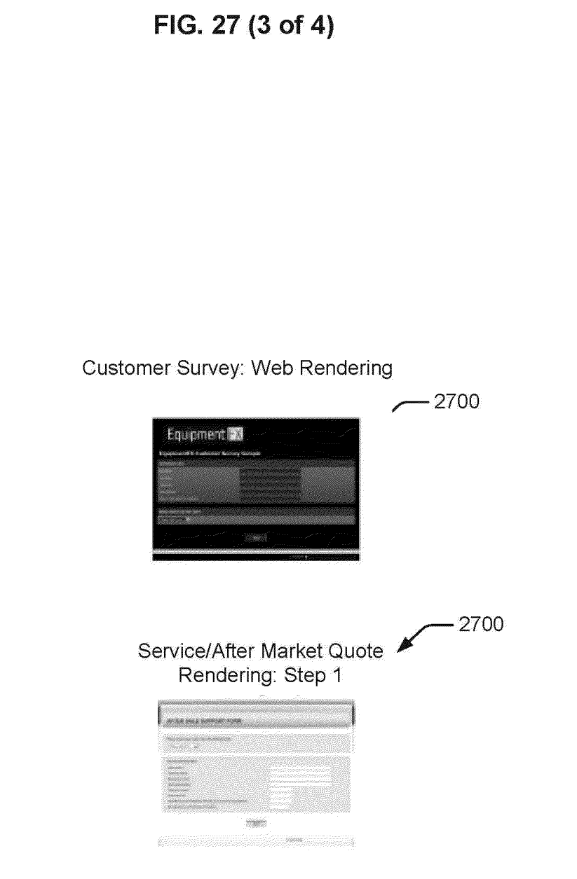

FIG. 26 illustrates a GUI of a notification center associated with marketing used industrial equipment. The GUI 2600 includes controls 2602, 2604, 2606, 2608, 2610, 2612, etc. and/or other GUI elements related to, respectively, a notifications view, a today view, a today summary, a next destination, a calendar day view, reminders, etc. Thus, users can receive, send, view, manage their notifications via GUI 2600 and the underlying application(s).

Moreover, systems 200 (in whole or in part) can provide an integrated set of business practices, processes, applications, application suites, etc. These application suites provide an ecosystem that allows all stakeholders (for instance, buyers, sellers, administrators, inspectors, etc.) to participate in a system that includes inventory management processes and that shortens time to market and/or days to sale metrics. Thus, some of these application suites often increase inventory turnover and lower interest costs. Moreover, application suites of embodiments provide tools which allow these stakeholders to streamline manual, cumbersome, etc. processes. Some application suites provide better access to information for end users about the different equipment available at different sellers and empower stakeholders to perform their activities more effectively and/or on mobile devices with collaborative technologies.

Application suites of embodiments provide separate modules for the various stakeholders to create, modify, view, search for, manage, act on (for instance, contact other parties related to listings), etc. listings using their mobile devices. Moreover, once a listing becomes dated, some application suites, allow the seller to re-publish the listing to third party publications, websites, etc. (for instance Resale Weekly) with a tap on a GUI. That GIU can also be configured to provide feedback regarding whether the listing was re-published. Such application suites can also pass on customer information to the seller who posted the listing in situations where a user makes a query about the listing. That GUI can also display the posting on the third party website. Moreover, that GUI can provide the capability to write a listing's information into the third party system so that the listing gets reflected into the third party system.

Some application suites provide portals where different users can register and/or create their primary accounts and/or multiple accounts. This portal can be the central site where all accounts are created and/or managed. Once they are registered they can be allowed access to the various modules, mobile solutions, applications, etc. which can then be used to create inspection reports, transform them to listings, etc. The portal and/or web server can be a driver which manages listings, accounts, etc.

Mobile and/or cloud-based applications of embodiments can push/pull data from showrooms, inventory managers, etc. via application process interfaces (APIs) provided by such application suites. Listing templates including SEO (search engine optimization), video SEO, text SEO, etc. can be provided in accordance with embodiments to optimize various listings. Inventory listing managers of embodiments are provided which include one-tap methods in conjunction with pre-selected tap sequences for common activities on the various mobile devices and/or other computing devices.

Embodiments provide applications which allow users to initiate listings and/or manage the process from smart devices and/or desktop computers. Moreover, some of the one tap/tap sequence applications along with their integrated forms, processes, etc. allow users to create videos, organize photos, conduct inspections, post inspection reports, etc. for next step evaluations. Embodiments provide condition report ranking systems allowing problem area identification including (in some embodiments) prompting the user to create a note regarding the same. Moreover, applications of embodiments provide for the creation of “voice notes” for subsequent distribution to other users.

Applications of embodiments provide equipment descriptions. These descriptions can be public or private and can allow users to manage servicing/repairing of the equipment in either wholesale or retail or both environments. Dealer profiles can be provide which automatically populate various forms, inspection reports, etc. with data pertinent to the particular dealers thereby minimizing key strokes, manual data entry, etc.

Furthermore, some application suites create virtual market places. The applications thereof can provide automated and/or self-activated push/pull of inventory data to other media sites via APIs, XML feeds, RSS feeds, etc. between private showrooms, third party sites, etc. Applications of embodiments provide video tutorials that are self-prompting/educating regarding the inspection, listing, and/or other processes. Applications of embodiments provide for dashboard/mobile device management of leads, contacts, quotes, online publishing, etc. via one tap and/or tap sequence processes. Moreover, some applications provide for one tap/tap sequence based auctions services and/or platforms. Such auction services can stream inventory data to market places and/or auctions on periodic (and/or other) schedules.

Application suites of embodiments provide cloud, backup, customer/data management, etc. services, platforms, technologies, etc. At least some of these services can be provided via mobile devices and can explain to users where their data is stored. Moreover, in accordance with embodiments, users can create and/or manage their settings as they desire with their mobile devices and/or other computing devices. User/listing data can be password protected and/or only accessible to selected users via various permissions.

In operations, application suites of some embodiments operate as follows. All users who desire to user the system can register. They can create their own profiles and set their settings in accordance with their desired roles and/or the application suites can populate these settings with default values. Various sellers can then create their listings wherein these listings can contain a rich mixture of picture galleries, video galleries, inspection forms, etc. with/without location/time stampings. The seller or someone associated therewith can assign prices to the various pieces of equipment via the inspection reports/listings. These listings can be optimized for use on mobile devices and/or search engine optimized. Users can use email, texting, social messaging, etc. capabilities built into the application suites of embodiments to communicate with each other via their mobile devices and/or other computing platforms. Moreover, users can shortlist various pieces of equipment/listings/inspection reports as favorites to create their oen, personal inventory and/or share them via email, text, social media, etc. built in to the application suites of embodiments.

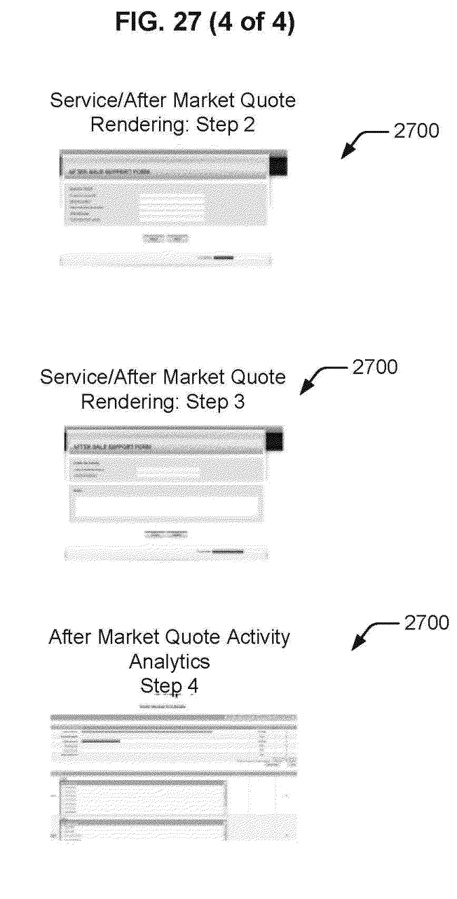

Some application suites include dealer deals, customer surveys, sales & service scheduler, and aftermarket quote, applications. FIG. 27 illustrates a GUI 2700 for one such application suite.

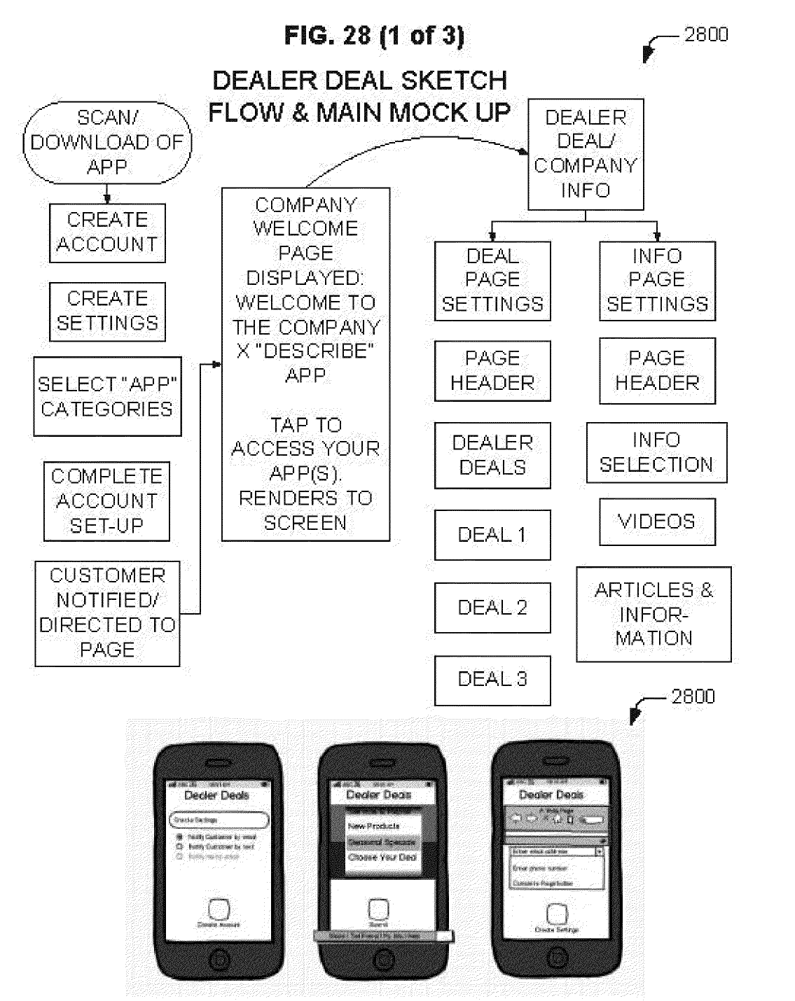

Application suites of some embodiments include customer surveys, dealer deals, inventory management, equipment inspections, service schedulers, after market sales schedulers applications. Application suites and/or applications of the current embodiment can provide such applications in a cloud-based, software as a service (SaaS) environment. Moreover, such application suites can improve inventory turns for new and/or used industrial equipment. Furthermore, applications for check-in, inspection, list equipment for sale, and/or managing such processes can be included in such application suites. Moreover, such application suites can be tailored for use on mobile deices and/or other computing devices with a web-based back end for common data entry processes. Such application suites provide a number of features. For instance, they provide for social sharing one tap publishing, push to auction, SaaS business modeling, frequent updates, minimized or no software (on mobile devices), etc. in some embodiments. Furthermore, in some embodiments these application suites provide best in class photo, video, inspection processes, and/or technology. Applications can also provide lead management, speed and accessibility of information via cloud based computing. User accounts can also be created managed, and reported via some application suites. FIG. 28 illustrates a GUI 2800 of such an application suite.

With continuing reference to FIG. 28, applications for mobile deviceds of some embodiments can be integrated between web, .mob, mobile application and/or inventory management platforms. They can provide for outward sharing (with viral possibilities) over services such as Facebook, Twitter, LinkedIn, SMS text features, etc. which allow users to share listings via their mobile applications with other potential users. Applications of such embodiments can create their accounts, set their settings, and receive their notifications via self management applications.

Still with reference to FIG. 28, some surveys provide for cumulative rates and/or net promotor scores. Some applications allow users to recall deals, surveys, messages, quotes with/without thumbnail images and/or descriptions. Settings of some applications include notification, buyer/seller type, equipment preference, etc. settings. Activity management features can include saving, deleting, organizing by date, adding contacts, sharing contacts, etc. capabilities. Tap sequences in accordance with embodiments include create account/log-in, create deals/surveys/quotes, submit activities, analyze activities, etc. pre-selected sequences. Applications of embodiments can provide for real time aggregation and/or scoring of various analytics related to dealer cumulative, branch/employee cumulative, totals, etc.

Further still, some application suites provide web platforms to manage inventory via the web with integrated e-commerce capabilities. Application suites of embodiments are compatible with various operating systems such as iOS, Android and/or they can be device/operating system agnostic so that they can render on all devices. Moreover, they can be programmed in HTML 5, Tomkat, CVS, and/or other languages which can be rich in code-based development. Applications can use standard formats for data feed from field and/or desktop publishing. APIs provided by embodiments can receive, consume, send data between an underlying database and/or user locations. Application suites of embodiments can be updated periodically or otherwise.

Embodiments provide inventory and listing manager with publishing applications. These applications provide mobile showrooms, inspection managers, and photo organizers, sales sites, and lead manager applications. The mobile showroom applications can be web-based and configured to render on smart phones, tablets, etc. and render thereon various equipment listings. The inspection manager and photo organizer applications can initiate a process to track assets from inspection to sales to end users. Sale sites applications can be personalized for the sales representative (and/or other users) and can have the capability to manage inventory, share featured listings, send/receive messages, etc. The lead manager applications of embodiments can provide recall capabilities and can manage leads, contacts, etc. via a database solution.

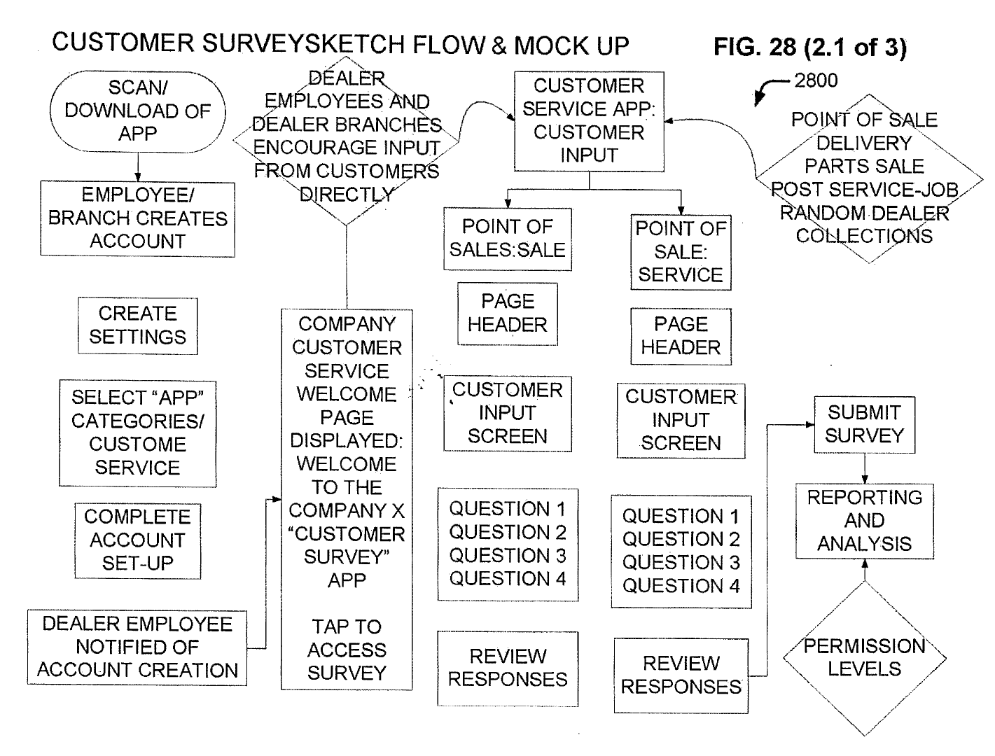

FIG. 29 illustrates a GUI 2900 for an application suite of embodiments. It includes controls and/or other GUI elements for accessing various applications such as those related to messaging, activity manager, analytics, inventory manager leads, quotes, surveys, deals, service, list-searching, etc. (respectively 2902, 2904, 2906, 2908, 2910, 2912, 2914, 2916, 2918, 2920, etc.). Tapping on one or more of these icons 2902, 2904, 2906, 2908, 2910, 2912, 2914, 2916, 2918, and/or 2920 can launch the corresponding application thereby allowing the user to access the corresponding capabilities. Moreover, application suites of embodiments can provide security for the users and their activities, data, information, etc. Application suites can be modularized and can be scaled to be licensed to various users from individuals to companies. Moreover, application suites of embodiments can provide best in class security, backup services, etc. Additionaly, applications of some embodiments are configured to generate unique QR codes for various pieces of equipment thereby facilitating information sharing between various users.

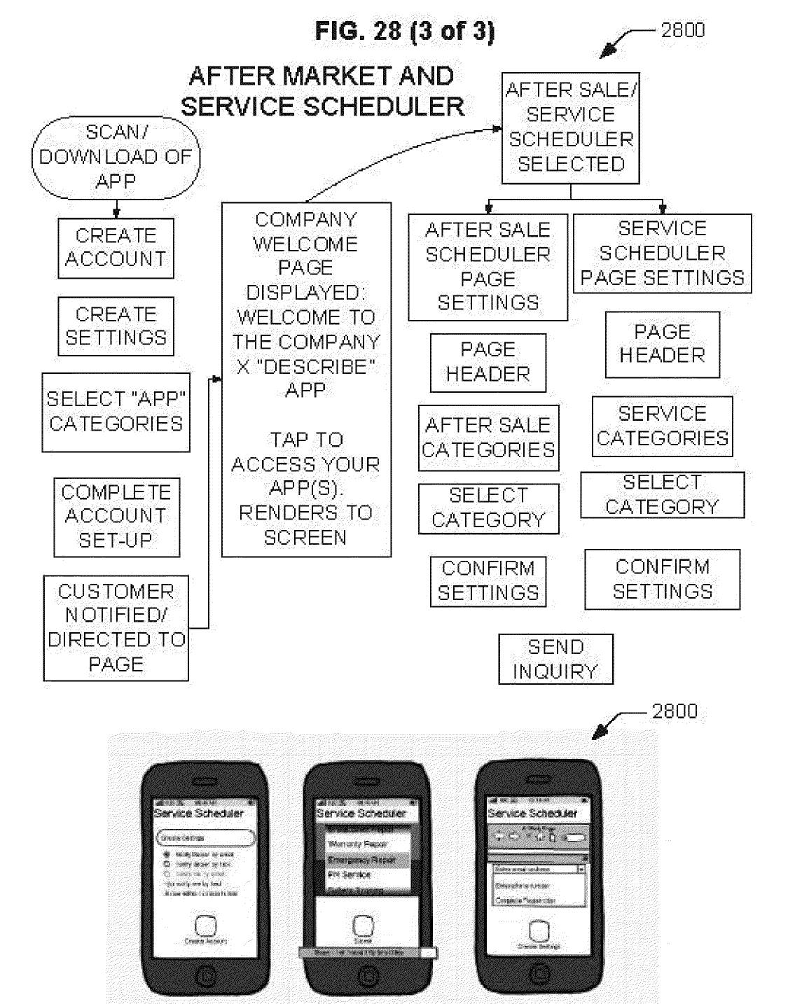

FIG. 30 illustrates a dashboard GUI 3000 for an application suite of embodiments. It includes tappable controls 3002, 3004, 3006, 3008, 3010, 3012, 3014, 3016, and 3018 and/or other GUI elements for accessing applications related to their communities, their blogs, their logins, their stores, their photos, their videos, their profiles, their messages, and additional applications. For instance, the community icon 3002 of embodiments allows user to create and manage their communities via the underlying application.

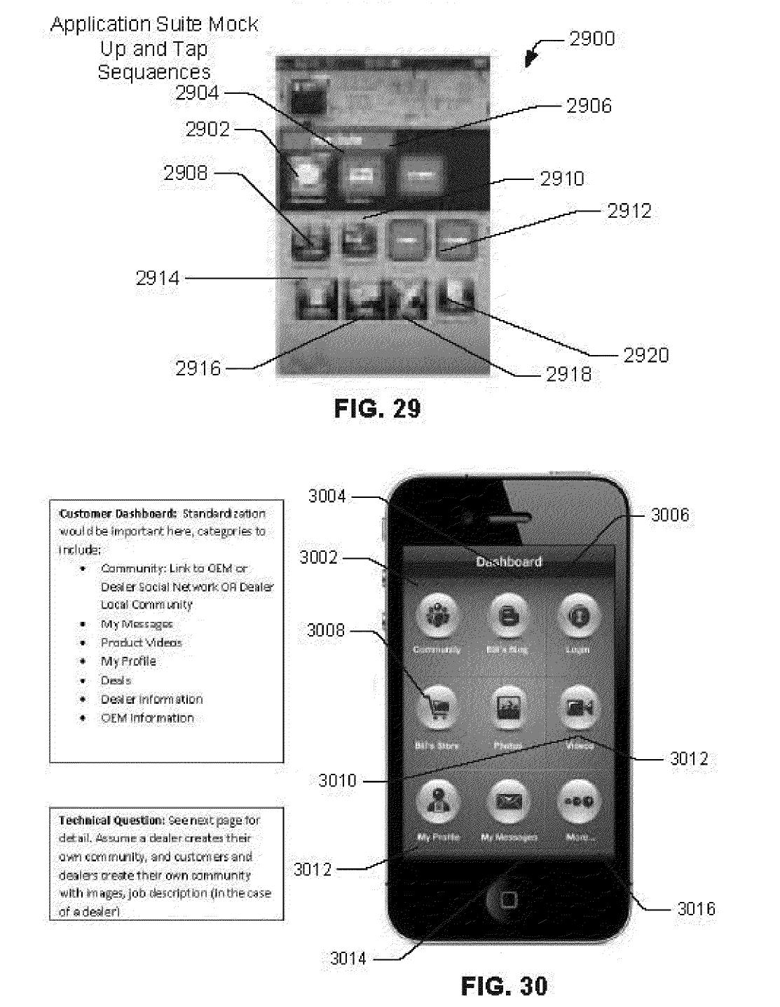

FIG. 31 illustrates a dealer deals summary GUI 3100. The dealer deals summary GUI allows dealers to promote deals for their various locations. It also allows users (for instance buyers) to download the underlying application, select dealer stores (perhaps in accordance with the user's settings), and receive a map of the dealer location(s). Each deal displayed on the dealer deal summary GUI 3100 can include a thumbnail rendered thereon, a brief description of the deal, a “view deal” control, etc.

Moreover, other GUIs could present articles and/or videos related to equipment-related intersts of the user. For instance, some GUIs could display cpmany news and/or product videos. Some GUIs can display blogs, blog articles, news, information etc. related to the user's equipment-related interests.

Further still, application suites of embodiments can provide applications related to check-ins, inspections, equipment listings, sales, and/or managing such activities. Such application suites can have web-based back ends for common data entry processes and/or can be tailored for display on mobile devices and/or other computing devices. These applications can be field-enabled thereby allowing users in the field to participate in bringing equipment into related systems. Such application can reduce the time/manpower while increasing efficiency in related workflows. Moreover, the GUIs related to these applications can be optimized and/or have associated therwith pre-selected tap sequences which reduce and/or optimize the effort, time, etc. associated with retrieving and/or using information.

Application suites of some embodiments allow users a variety of functionality. For instance, some applications allow users to notify other users of equipment newly available for bids, inspections, check-ins, etc. Furthermore, some applications allow users to manage related wholesale and/or retail processes when moving equipment through them. Moreover, these applications can integrate with payment gateways, ecommerce systems, etc. to facilitate deal making/execution over systems of embodiments. Such applications can allow for these activities at various sites such as the inspection sites, the seller's sites, the buyer's sites, etc. Further still, applications can provide both online and offline capabilities.

In accordance with various embodiments, application suites can implement best practices related to such areas as w3c, usability, organic search, server setup, security, rich media, content delivery, accessibility, etc. in some situations, users use their own equipment but use application suites of various embodiments to inspect and/or send listings to dealers and/or other users for evaluation and/or bidding. Moreover, H264, MPEG4 level 10 and/or MP4 video types/standards can be used for various images, bandwidth optimization, playback, compression using entropy encoding, macro blocks, adaptive bit rate, and/or other purposes. Further still, CPU cycle optimization can be achieved through alignment of server/video compression techniques. Some embodiments allow for video streaming to mobile devices and/or video SEO. Furthermore, various content distribution nettworks such as Akami can be used to facilitate activities with application suites of embodiments.

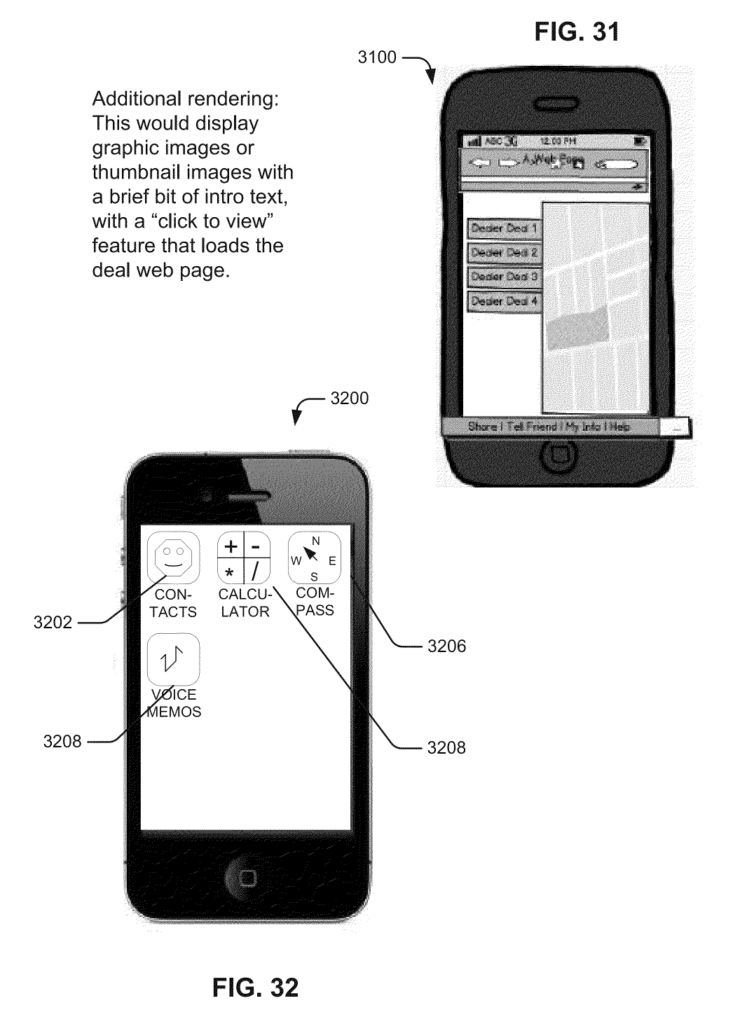

FIG. 32 illustrates a GUI for a utilities application suite. More specifically, the GUI 3200 includes controls 3202, 3204, 3206, 3208, etc. for various utilities that can be integrated into application suites of embodiments. These controls 3202, 3204, 3206, 3208, etc. can provide functionality associated with a user's contacts, a calculator, a compass, and/or voice memos/notes.

Thus, systems, apparatus, and methods have been provided for inspecting, selling, buying, marketing, etc. pieces of used industrial equipment. These methods allow users, through tap GUIs, to quickly and conveniently perform many of the foregoing activities. Further still, systems of embodiments allow the users thereof to participate in these activities in a trusted environment and, more specifically, in a trusted environment enforced by an administrator and/or the community of users. Such systems allow buyers and sellers to search for, list, buy, sell, etc. such equipment without necessarily meeting and/or traveling to the equipment. Moreover, systems of embodiments allow buyers to virtually inspect such equipment over telecommunications systems rather than spending the time and money to travel to do so in person.

### CONCLUSION

Although the subject matter has been disclosed in language specific to structural features and/or methodological acts, it is to be understood that the subject matter defined in the appended claims is not necessarily limited to the specific features or acts disclosed above. Rather, the specific features and acts described herein are disclosed as illustrative implementations of the claims.

1. A system comprising:
a server in communication with a network and being in use in an environment wherein used industrial equipment is being advertised for sale, wherein a pre-determined number of industrial equipment types exist, wherein each piece of used industrial equipment being advertised is one of those pre-determined industrial equipment types, and wherein each industrial equipment type has associated therewith a pre-determined number of components;
a plurality of mobile client devices in communication with the network;
a file stored on the server and being configured to contain information regarding a used condition of a piece of used industrial equipment, the used condition information further comprising an inspection report configured to reflect the type of industrial equipment to which the piece of used industrial equipment belongs and to further reflect conditions of the predetermined components associated with the industrial equipment type wherein the mobile client devices are configured to access the file, ascertain the type of industrial equipment, and to display the inspection report including the used condition as it relates to the piece of used industrial equipment and its pre-determined components;
wherein at least one of the mobile client devices further comprises an inspection tool configured to generate the inspection report reflecting the equipment type and to communicate the inspection report to the server; and
wherein the inspection report has associated therewith an indication of a trustworthiness of an originator of the inspection report.

2. A system for use in an environment wherein used industrial equipment is to be advertised for sale, wherein a pre-determined number of industrial equipment types exist, wherein each piece of industrial equipment is to be one of those pre-determined industrial equipment types, and wherein each industrial equipment type has associated therewith a pre-determined number of components, the system comprising:
a server in communication with a network configured for communications with a plurality of client devices; and
a file stored on the server and being configured to contain information regarding a used condition of a piece of used industrial equipment, the used condition information further comprising an inspection report configured to reflect the type of industrial equipment to which the piece of used industrial equipment belongs and to further reflect the predetermined components associated with the industrial equipment type wherein the client devices are configured to access the file, ascertain the type of industrial equipment, and to display the inspection report including the used condition as it relates to the piece of used industrial equipment and its pre-determined components.

3. The system of claim 2 wherein the inspection report includes a voice note recorded on a client device.

4. The system of claim 2 wherein the inspection report includes a video related to a component of piece of used industrial equipment.

5. The system of claim 2 wherein the inspection report has associated with it a geo-location tag reflecting the location at which the inspection occurred.

6. The system of claim 5 wherein the inspection has associated with it a timestamp reflecting a time at which the inspection occurred.

7. The system of claim 2 wherein at least one of the client devices further comprises an inspection tool configured to generate the inspection report reflecting the equipment type and to communicate the inspection report to the server.

8. The system of claim 7 wherein the inspection tool is further configured to integrate a video into the inspection report.

9. The system of claim 2 further comprising a dealer server in communication with the network and configured to store a plurality of used industrial equipment files wherein each of the used industrial equipment files further comprises an inspection report for a corresponding piece of used industrial equipment.

10. The system of claim 2 wherein one of the client devices is configured to indicate a service status of a piece of used industrial equipment and wherein the inspection report remains private while the service status is incomplete.

11. The system of claim 2 wherein the inspection report has associated therewith an indication of its trustworthiness.

12. A server for use in an environment wherein used industrial equipment is to be advertised for sale, wherein a pre-determined number of industrial equipment types exist, wherein a piece of industrial equipment is to be one of those pre-determined industrial equipment types, and wherein each industrial equipment type has associated therewith a pre-determined number of components, the server comprising:
a processor in communication with a network configured for communications with a plurality of client devices;
a memory storing a file configured to contain information regarding a condition of a piece of used industrial equipment, the condition information further comprising an inspection report configured to reflect the type of industrial equipment to which the piece of used industrial equipment belongs and to further reflect the predetermined components associated with the industrial equipment type wherein the client devices are configured to access the file, ascertain the type of industrial equipment, and to display the inspection report including the condition as it relates to the piece of used industrial equipment and its pre-determined components; and
an interface configured to display the inspection report.

13. The server of claim 12 wherein the inspection report includes a voice note recorded on a client device.

14. The server of claim 12 wherein the inspection report includes a video related to a component of piece of used industrial equipment.

15. The server of claim 12 wherein the inspection report has associated with it a geo-location tag reflecting the location at which the inspection occurred.

16. The server of claim 15 wherein the inspection has associated with it a timestamp reflecting a time at which the inspection occurred.

17. The server of claim 12 wherein at least one of the client devices further comprises an inspection tool configured to generate the inspection report reflecting the equipment type and to communicate the inspection report to the server.

18. The server of claim 12 wherein a dealer server in communication with the network is configured to store a plurality of used industrial equipment files wherein each of the used industrial equipment files further comprises an inspection report for a corresponding piece of used industrial equipment.

19. The server of claim 12 wherein one of the client devices is configured to indicate a service status of a piece of used industrial equipment and wherein the inspection report remains private while the service status is incomplete.

20. The system of claim 12 wherein the inspection report has associated therewith an indication of its trustworthiness.
